(19) United States
(12) Patent Application Publication
(10) Pub. No.: US 2023/0087711 A1
(43) Pub. Date: Mar. 23, 2023

(54) INFORMATION PROCESSING APPARATUS, INFORMATION PROCESSING METHOD, AND NON-TRANSITORY COMPUTER READABLE MEDIUM

(71) Applicant: FUJIFILM BUSINESS INNOVATION CORP., Tokyo (JP)

(72) Inventors: Kazuko KIRIHARA, Kanagawa (JP); Nobuyuki SATO, Kanagawa (JP); Shohei KAWAKAMI, Kanagawa (JP); Takayoshi SUZUKI, Kanagawa (JP); Hiroo SEKI, Kanagawa (JP)

(73) Assignee: FUJIFILM BUSINESS INNOVATION CORP., Tokyo (JP)

(21) Appl. No.: 17/711,397

(22) Filed: Apr. 1, 2022

(30) Foreign Application Priority Data
Sep. 10, 2021 (JP) 2021-148184
Sep. 10, 2021 (JP) 2021-148185

(51) Int. Cl. H04N 1/00; G06F 3/01

(52) U.S. Cl. CPC H04N 1/00381; G06F 3/017; H04N 1/00395; H04N 1/00424; H04N 1/00482

(57) ABSTRACT

An information processing apparatus includes a processor configured to: accept an operation performed by a user in a contactless manner for each of items displayed on a screen; and control a confirmation time for each of the items including a first item and a second item to set a confirmation time for the first item to be shorter than a confirmation time for the second item, wherein the confirmation time for each of the items is a time that is taken from when an operation performed by the user on the item is detected to when it is confirmed that the operation is selection of the item on which the operation has been detected.

### CROSS REFERENCE TO RELATED APPLICATIONS

This application is based on and claims priority under 35 USC 119 from Japanese Patent Application No. 2021-148184 filed Sep. 10, 2021 and Japanese Patent Application No. 2021-148185 filed Sep. 10, 2021.

### BACKGROUND

### (i) Technical Field

The present disclosure relates to an information processing apparatus, an information processing method, and a non-transitory computer readable medium.

### (ii) Related Art

Japanese Unexamined Patent Application Publication No. 2011-118511 discloses a display device for performing an operation on a setting item displayed on a display screen in response to a user operation. The display device includes operation detection means for detecting a position of a detection target relative to an operation surface for performing the operation as a coordinate position on the operation surface and as a distance from the operation surface and outputting detection-target position information indicating the position of the detection target; setting item display means for displaying on the display screen a display object indicating a setting item for which a set value is adjustable; and set value update means for updating a set value for the setting item displayed on the display screen in accordance with a distance between the detection target detected by the operation detection means and the operation surface.

### SUMMARY

Contactless user interfaces that allow users to operate items displayed on screens in a contactless manner have been introduced in recent years. A user who is to select an item in a contactless manner holds their finger over a display area of the item to be selected. An existing contactless user interface recognizes that, when a display area including an item to be selected is pointed at by a user with their finger for a predetermined time (referred to as a “confirmation time”) or longer, the item in the display area pointed at with the finger is selected to identify whether the selection of the item by the user is based on the user’s intention.

Accordingly, the existing contactless user interface takes a longer time to confirm the selection of an item than a user interface that allows contact operation of an item displayed on a screen.

Aspects of non-limiting embodiments of the present disclosure relate to an information processing apparatus, an information processing method, and a non-transitory computer readable medium for allowing a user to select an item on a screen, when operating items displayed on the screen in a contactless manner, with higher operability than that when a confirmation time taken from when a selection made by the user is detected to when the detected selection is confirmed to be based on the user’s intention is uniformly set for all the items.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: accept an operation performed by a user in a contactless manner for each of items displayed on a screen; and control a confirmation time for each of the items including a first item and a second item to set a confirmation time for the first item to be shorter than a confirmation time for the second item, wherein the confirmation time for each of the items is a time that is taken from when an operation performed by the user on the item is detected to when it is confirmed that the operation is selection of the item on which the operation has been detected.

### BRIEF DESCRIPTION OF THE DRAWINGS

Exemplary embodiments of the present disclosure will be described in detail based on the following figures, wherein:

FIG. 1 illustrates an example configuration of an information processing system according to one or more exemplary embodiments;

FIG. 2 is a perspective view of an example of a substantial part of an image processing apparatus according to one or more exemplary embodiments;

FIGS. 3A and 3B illustrate an example of an operation panel configured to be operated in a contactless manner according to one or more exemplary embodiments;

FIG. 4 illustrates an example functional configuration of the image processing apparatus according to one or more exemplary embodiments;

FIG. 5 illustrates an example of screen transition according to one or more exemplary embodiments;

FIG. 6 illustrates an example of how a “Copy” button is selected according to one or more exemplary embodiments;

FIG. 7 illustrates an example configuration of a substantial part of an electric system of the image processing apparatus according to one or more exemplary embodiments;

FIG. 8 is a flowchart illustrating an example of the flow of an operation process according to an exemplary embodiment;

FIG. 9 is a flowchart illustrating an example of the flow of an operation process for adjusting a confirmation time for an operation object in accordance with the manner of an operation of a user according to an exemplary embodiment;

FIG. 10 illustrates a difference in location between detected operation positions according to an exemplary embodiment;

FIG. 11 is a flowchart illustrating an example of the flow of an operation process for adjusting a confirmation time for an operation object in accordance with a detection position of an operation in a display area of the operation object according to an exemplary embodiment;

FIG. 12 illustrates the sizes of ranges of detected operation positions according to an exemplary embodiment;

FIG. 13 is a plan view of an example of a home screen according to an exemplary embodiment;

FIG. 14 is a plan view of an example of a detection area whose size is increased in the home screen according to an exemplary embodiment;

FIG. 15 is a plan view of an example of an operation object whose size is increased in the home screen according to an exemplary embodiment;

FIG. 16 is a plan view of a modification of an operation object whose size is increased in the home screen according to an exemplary embodiment;

FIG. 17 is a plan view of an example of an operation object selected in the home screen according to an exemplary embodiment;

FIG. 18 is a plan view of an example of a detection area whose shape is changed in the home screen according to an exemplary embodiment;

FIG. 19 is a plan view of another example of a detection area whose shape is changed in the home screen according to an exemplary embodiment; and

FIG. 20 is a flowchart illustrating an example of a process based on an information processing program according to an exemplary embodiment.

### DETAILED DESCRIPTION

Exemplary embodiments of the present disclosure will be described hereinafter with reference to the drawings. Substantially the same components and substantially the same processes are denoted by the same reference numerals throughout the drawings, and redundant description thereof will be omitted.

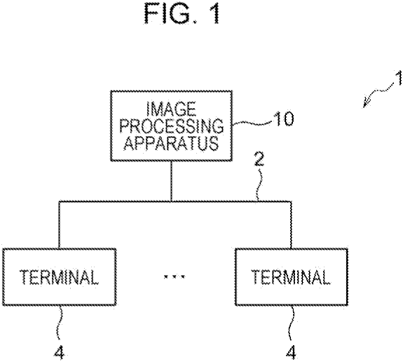

FIG. 1 illustrates an example configuration of an information processing system 1 including an information processing apparatus. The information processing apparatus includes a contactless user interface through which a user performs an operation in a contactless manner. The information processing apparatus in the information processing system 1 may be applied to any field as long as the information processing apparatus includes a contactless user interface. Examples of the information processing apparatus include an automatic teller machine (ATM), a vending machine, and an automatic ticket dispenser. The information processing apparatus may be for personal use only or usable by an unspecified number of users.

For example, an image processing apparatus 10 installed in a workplace will be described hereinafter as an example of the information processing apparatus.

As described below, the image processing apparatus 10 is configured to execute functions related to images in accordance with instructions from users. The image processing apparatus 10 is connected to, for example, a plurality of terminals 4 to be used by individual users via a communication line 2.

Each user transmits image data generated by a corresponding one of the terminals 4 to the image processing apparatus 10 through the communication line 2 to cause the image processing apparatus 10 to execute desired image processing. Alternatively, a user may bring a portable storage medium such as a Universal Serial Bus (USB) memory or a memory card storing image data to the image processing apparatus 10 and connect the portable storage medium to the image processing apparatus 10 to cause the image processing apparatus 10 to execute desired image processing. Alternatively, a user may bring a document having at least one of text or an image to the image processing apparatus 10 and make the image processing apparatus 10 read the document to cause the image processing apparatus 10 to execute desired image processing.

The communication line 2 may be of any type that provides a connection between the image processing apparatus 10 and the terminals 4, such as a wired connection, a wireless connection, or a combination of wired and wireless connections. In addition, any number of terminals 4 may be connected to the image processing apparatus 10. For example, none of the terminals 4 may be connected to the image processing apparatus 10.

The terminals 4 are information devices configured to be used by users. The terminals 4 may be any type of information device having a data storage function and a data communication function. The terminals 4 include, for example, computers intended to be used at fixed positions, and mobile terminals intended to be transported and used, such as smartphones and wearable devices.

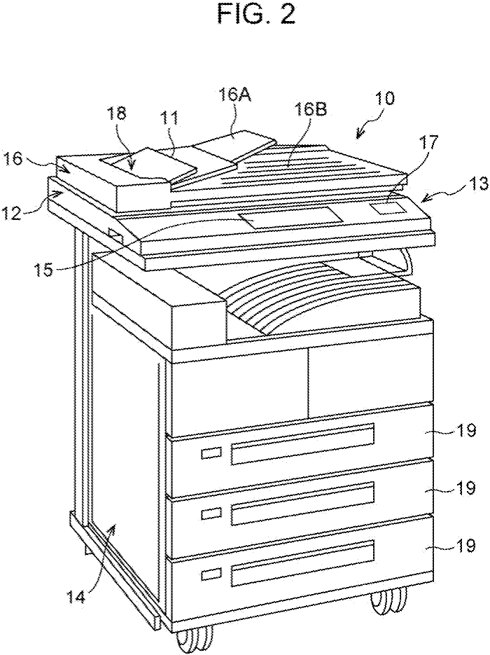

FIG. 2 is a perspective view of a substantial part of the image processing apparatus 10. The image processing apparatus 10 has, for example, a scan function for reading an image on a recording medium such as paper as image data, a print function for forming an image represented by image data on a recording medium, and a copy function for forming the same image as an image formed on a recording medium onto another recording medium. The copy function, the print function, and the scan function are examples of image processing to be performed by the image processing apparatus 10.

The image processing apparatus 10 illustrated in FIG. 2 includes, for example, a document reading unit 12 and an image forming unit 14. The document reading unit 12 is located in an upper portion of the image processing apparatus 10, and the image forming unit 14 is located below the document reading unit 12.

The document reading unit 12 includes an optical reading device (not illustrated) and a document transport device 18. The document transport device 18 is disposed in a document cover 16. The document cover 16 is provided with a document table 16A, on which documents 11 are placed. The document transport device 18 sequentially feeds each of the documents 11 on the document table 16A and transports the documents 11 onto a transported-document scanning glass (not illustrated). The document reading unit 12 reads the content of the document 11 transported onto the transported-document scanning glass (not illustrated) as image data using the optical reading device (not illustrated). Thereafter, the document transport device 18 discharges the document 11 whose content has been read onto a discharge table 16B included in the document cover 16.

The image forming unit 14 forms an image represented by image data on a recording medium. Recording media are stored in storage trays 19 that are classified by the type or size of recording media. The image forming unit 14 may form an image in any color on a recording medium and may form a color image or a monochrome image.

The image processing apparatus 10 includes, in a front portion thereof, an operation display unit 13 that accepts an operation for executing various functions such as the copy function, the print function, and the scan function from a user.

Specifically, the operation display unit 13 includes a reader device 17 that acquires information on a user who performs an operation, and an operation panel 15 that accepts an operation of the user.

For example, in response to the user bringing their employee identity card close to the reader device 17, the reader device 17 reads identification information (referred to as a “user ID”) for uniquely identifying the user from an integrated circuit (IC) chip incorporated in the employee identity card in a contactless manner.

The operation panel 15 is a display having a touch panel superimposed thereon. The operation panel 15 displays an operation object to be operated by the user to execute a desired function. The operation object may be of any type that is to be operated by the user, and includes, for example, a button, a scroll bar, a check box, and a radio button. In response to the user performing an operation on the operation object, the image processing apparatus 10 executes a process associated in advance with the content of the operation, and a response to the operation is displayed on the operation panel 15.

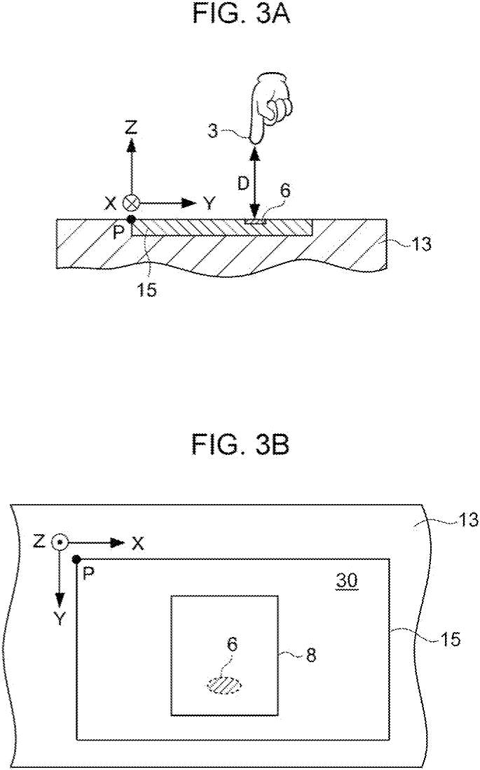

The operation panel 15 detects the position of the user’s finger, that is, an operation position 6 (see, for example, FIG. 3A), in a contactless manner. The phrase “detecting the operation position 6 in a contactless manner” refers to detecting the position of the user’s finger in response to the user holding the finger over a location that is in a space above a display surface of the operation panel 15 and that does not come in contact with the display surface of the operation panel 15 within a range of the display surface of the operation panel 15 without pressing the finger against the display surface of the operation panel 15. A space extending in the normal direction of the display surface of the operation panel 15 within the range of the display surface of the operation panel 15 is hereinafter referred to as a space “over the operation panel 15” or “above the operation panel 15”. Thus, the phrase “over the operation panel 15” or “above the operation panel 15” does not mean the upper side of the operation panel 15 based on the up, down, left, and right directions in the real space, but means a space in a direction facing the display surface of the operation panel 15. Accordingly, when the display surface of the operation panel 15 is inclined with respect to the floor, a space in an oblique direction perpendicular to the display surface of the operation panel 15 is a space over or above the operation panel 15.

The phrase “holding the user’s finger over something (such as the operation panel 15)” means that the user points at a space over the operation panel 15 with their finger without touching the display surface of the operation panel 15.

FIGS. 3A and 3B illustrate an example of the operation panel 15 that allows detection of the operation position 6 of the user in a contactless manner. FIG. 3A is a sectional view of the operation panel 15, and FIG. 3B is a plan view of the operation panel 15 when viewed in a direction facing the display surface of the operation panel 15.

The operation panel 15 includes a so-called capacitive touch panel that detects the operation position 6 from a change in electrostatic capacitance caused by the user holding their finger over the operation panel 15. In the operation panel 15 including such a touch panel, a change in electrostatic capacitance at a position closest to the user’s finger is larger than a change in electrostatic capacitance at any other position. Accordingly, the operation panel 15 outputs, as the operation position 6 of the user, a portion where the change in electrostatic capacitance is largest within the range of the operation panel 15.

To identify the operation position 6 of the user relative to the operation panel 15, an operation coordinate system is defined for the operation panel 15. The operation coordinate system is represented as a three-dimensional coordinate system having any position on the operation panel 15 as an origin P. In the example of the operation panel 15 illustrated in FIGS. 3A and 3B, the origin P is set at one of the vertices of the outline of the rectangular operation panel 15. In the example of the operation panel 15 illustrated in FIGS. 3A and 3B, furthermore, an X axis is set along a lateral direction of the operation panel 15 with respect to the origin P, a Y axis is set along a longitudinal direction of the operation panel 15 with respect to the origin P, and a Z axis is set so as to be perpendicular to the X and Y axes. The Z-axis direction is referred to as a height direction of the operation panel 15, and the Z axis represents the normal direction of the display surface of the operation panel 15.

The operation position 6 of the user relative to the operation panel 15 is represented by a coordinate point (x, y), which is a combination of the coordinate value x of the X coordinate and the coordinate value y of the Y coordinate of a position where the change in electrostatic capacitance is largest within the range of the operation panel 15.

When the operation panel 15 displays operation objects, an operation object displayed so as to include the operation position 6 of the user is recognized as the operation object being operated by the user. In the example of the operation panel 15 illustrated in FIG. 3B, the operation position 6 of the user is included in a display area of a button 8 arranged in a screen 30 displayed on the operation panel 15. Thus, the user is recognized as operating the button 8. An operation object displayed so as to include the operation position 6 of the user may be hereinafter referred to as an “operation object corresponding to the operation position 6”. The operation position 6 is an example of a “detection position at which the operation performed by the user has been detected” according to this exemplary embodiment.

As illustrated in FIG. 3A, if the length of a perpendicular drawn from a body part 3 (e.g., a finger) of the user, which is held over the operation panel 15, to the display surface of the operation panel 15, that is, the distance from the body part 3 of the user to the operation panel 15 in the height direction of the operation panel 15, is represented by an “operation distance D”, the change in electrostatic capacitance at the operation position 6 of the user increases on the operation panel 15 as the operation distance D decreases. Conversely, as the operation distance D increases, the change in electrostatic capacitance at the operation position 6 of the user decreases on the operation panel 15. Accordingly, associating the operation distance D with the amount of change in electrostatic capacitance in advance makes it possible to obtain the operation distance D from the amount of change in electrostatic capacitance on the operation panel 15.

Based on the correspondence relationship between the operation distance D and the amount of change in electrostatic capacitance, the operation panel 15 recognizes the operation position 6 of the user not only as a two-dimensional operation position 6 along the display surface of the operation panel 15 but also as a three-dimensional operation position 6 that takes the operation distance D into account. That is, when the operation position 6 of the user is represented as a three-dimensional position, the operation position 6 of the user is represented by a coordinate point (x, y, z) obtained by combining a coordinate value z representing the operation position 6 in the height direction of the operation panel 15 with the coordinate point (x, y). The coordinate value z is a coordinate value, on the Z axis, of a position the operation distance D away from the origin P along the Z axis.

The coordinate value z = 0 means that the user is performing an operation while touching the display surface of the operation panel 15 with their finger. Accordingly, the image processing apparatus 10 also recognizes a difference in the manner of the operation of the user, such as whether the user is operating the operation panel 15 in a contactless manner or operating the operation panel 15 with their finger touching the operation panel 15. As described above, the operation panel 15 supports both a contact operation in which the user performs an operation while touching the display surface of the operation panel 15 with their finger and a contactless operation in which the user operates the operation panel 15 while holding their finger over the operation panel 15.

As described above, since the change in electrostatic capacitance at the operation position 6 of the user decreases on the operation panel 15 as the operation distance D increases, the operation distance D has an upper limit. If the user holds their finger over the operation panel 15 at a position exceeding the upper limit of the operation distance D, the electrostatic capacitance at the operation position 6 of the user does not change, and the operation panel 15 makes no response to the operation of the user. Accordingly, a recommended operation distance D is set for the operation panel 15. The recommended operation distance D is hereinafter referred to as a “reference operation distance”. The reference operation distance differs depending on the type of the operation panel 15 and is set to 3 cm as an example.

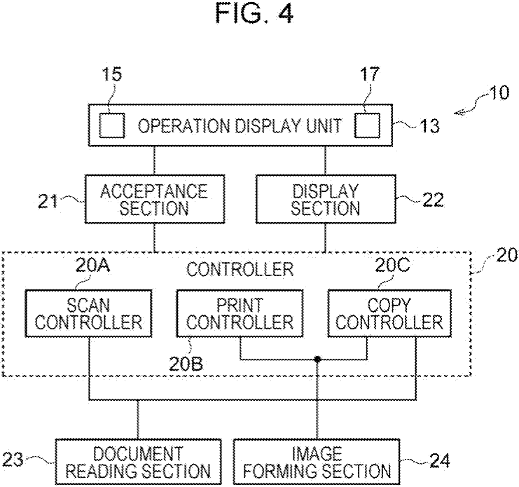

FIG. 4 illustrates an example functional configuration of the image processing apparatus 10. The image processing apparatus 10 includes functional sections, namely, a controller 20, an acceptance section 21, a display section 22, a document reading section 23, and an image forming section 24.

The acceptance section 21 accepts a user ID of a user who operates the image processing apparatus 10 from the reader device 17 of the operation display unit 13, and also accepts the operation position 6 of the user relative to the operation panel 15 from the operation panel 15 of the operation display unit 13. The acceptance section 21 further accepts image data from a portable storage medium connected to a terminal 4 or the image processing apparatus 10.

The acceptance section 21 notifies the controller 20 of the user ID, the operation position 6 of the user, and the image data, which have been accepted.

When notified of the user ID by the acceptance section 21, the controller 20 performs an authentication process to determine whether the user represented by the user ID is a user (referred to as a “registered user”) permitted to use the image processing apparatus 10. When notified of the operation position 6 of the user relative to the operation panel 15 by the acceptance section 21, the controller 20 determines whether the operation object corresponding to the operation position 6 of the user in the screen 30 displayed on the operation panel 15 is selected, and executes a process associated in advance with the selected operation object. For example, if the operation object is a button 8 for starting the print function, the controller 20 starts the print function to form an image represented by the image data accepted by the acceptance section 21 on a recording medium.

Since the image processing apparatus 10 has the copy function, the print function, and the scan function, the controller 20 includes a scan controller 20A that controls the scan function, a print controller 20B that controls the print function, and a copy controller 20C that controls the copy function. Any one of the scan controller 20A, the print controller 20B, and the copy controller 20C performs control in accordance with the content of the process associated with the operation object operated by the user.

When the operation performed by the user through the operation object is an operation related to the scan function, the scan controller 20A controls the document reading section 23 to implement the scan function. When the operation performed by the user through the operation object is an operation related to the print function, the print controller 20B controls the image forming section 24 to implement the print function. When the operation performed by the user through the operation object is an operation related to the copy function, the copy controller 20C controls the document reading section 23 to generate image data of the document 11. Thereafter, the copy controller 20C controls the image forming section 24 to form an image represented by the generated image data on a recording medium.

The document reading section 23 drives the document reading unit 12 under the control of the scan controller 20A and the copy controller 20C to, for example, transport each of the documents 11 placed on the document table 16A and generate image data of the transported document 11.

The image forming section 24 drives the image forming unit 14 under the control of the print controller 20B and the copy controller 20C to, for example, transport a recording medium stored in any of the storage trays 19 and form an image represented by the image data on the transported recording medium.

The display section 22 displays, for example, a result of the authentication process performed on the user and a result of the process executed by the controller 20 in response to the operation performed by the user through the operation object on the operation panel 15 in the operation display unit 13 in accordance with an instruction from the controller 20.

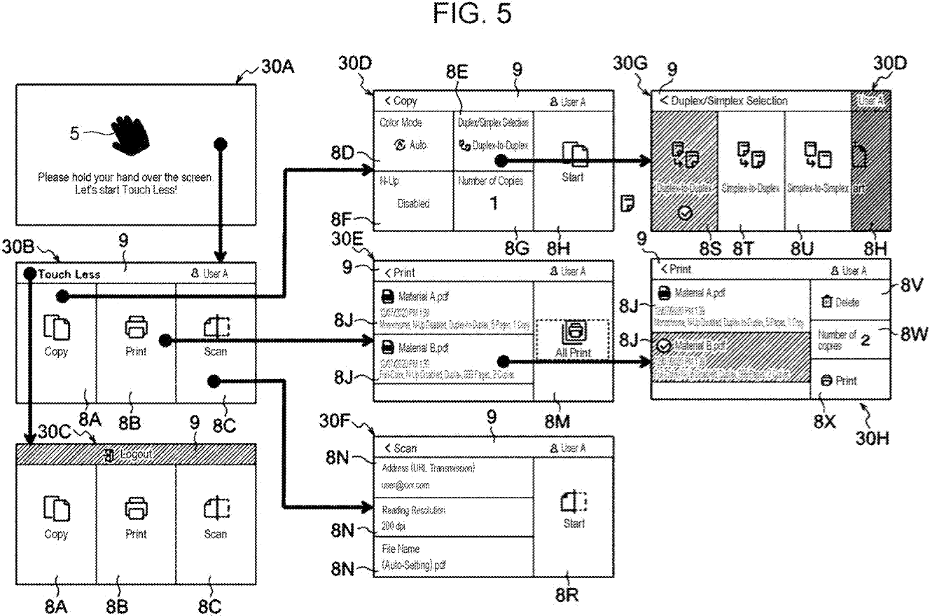

FIG. 5 illustrates an example transition of the screen 30, indicating how the screen 30 displayed on the operation panel 15 transitions in response to the user operating the operation panel 15. The display of the screen 30 on the operation panel 15, which is performed by the display section 22, may also be interpreted as the display of the screen 30 on the operation panel 15 that is performed by the controller 20 because the display section 22 displays the screen 30 in accordance with an instruction from the controller 20. A space extending along the Z axis and having a bottom surface corresponding to the display range of the screen 30 displayed on the operation panel 15 is expressed as a space “over the screen 30” or “above the screen 30”, and a space extending along the Z axis and having a bottom surface corresponding to the display range of the operation object displayed in the screen 30 is expressed as “over the operation object” or “above the operation object”.

Like the expression “over the operation panel 15” or “above the operation panel 15”, the expression “over the screen 30” or “above the screen 30” and the expression “over the operation object” or “above the operation object” do not mean the upper side of the screen 30 and the upper side of the operation object based on the up, down, left, and right directions in the real space, respectively, but mean a space in a direction facing the screen 30 and a space in a direction facing the operation object, respectively.

For convenience of description, screens 30 whose types are distinguished from each other are accompanied by different alphabet symbols associated with the types of the screens 30. Screens 30 whose types are not distinguished from each other are collectively expressed as the “screens 30” regardless of their types. Buttons 8, which are an example of operation objects, whose types are distinguished from each other are accompanied by different alphabet symbols associated with the types of the buttons 8. Buttons 8 whose types are not distinguished from each other are collectively expressed as the “buttons 8” regardless of their types.

When it is determined that the user who performs an operation is a registered user through the authentication process, the controller 20 causes a start screen 30A to be displayed on the operation panel 15. The start screen 30A displays an instruction given to the user, such as “Please hold your hand over the screen” and “Let’s start Touch Less!”, for example.

In response to the user holding their finger over the start screen 30A, the operation mode transitions to a contactless operation mode in which the user performs the subsequent operations without touching the operation panel 15. In response to the user pressing the operation panel 15 having the start screen 30A displayed thereon with their finger, in contrast, the operation mode transitions to a contact operation mode in which the user performs the subsequent operations with their finger touching the operation panel 15. An example in which the contactless operation mode is selected by the user will now be described. In response to a transition to the contactless operation mode, a cursor 5 is displayed at a position on the start screen 30A corresponding to the operation position 6 of the user. In the example of the start screen 30A illustrated in FIG. 5, the displayed cursor 5 is in the shape of a hand. The shape of the cursor 5 is an example, and, for example, a circular cursor 5 may be displayed. The cursor 5 to be displayed on each of the screens 30 other than the start screen 30A is not illustrated in FIG. 5, for convenience of illustration. In response the user holding their finger over the start screen 30A, a home screen 30B is displayed. The instruction given to the user in the start screen 30A is also used to instruct the user how to perform an operation on the operation panel 15.

The screens 30, including the home screen 30B, are each different in appearance between the contact operation mode and the contactless operation mode. For example, the contact operation mode and the contactless operation mode are different in at least one of the color of the operation objects, the size of the operation objects, or the arrangement of the operation objects in the screens 30.

Even if the user selects the contactless operation mode, the contactless operation mode may be switched to the contact operation mode in response to the user touching the operation panel 15 with their finger during operation. Even if the user selects the contact operation mode, the contact operation mode may be switched to the contactless operation mode in response to the user holding their finger over the operation panel 15 for a predetermined time or longer during operation. In addition, in response to the user selecting a button 8 for switching the operation mode, the contact operation mode and the contactless operation mode may be switched even during operation.

The home screen 30B displays, for example, buttons 8 for individually selecting the various functions of the image processing apparatus 10, and a navigation bar 9 for displaying information useful for the user to perform an operation. Since the image processing apparatus 10 has the copy function, the print function, and the scan function, a “Copy” button 8A for selecting the copy function, a “Print” button 8B for selecting the print function, and a “Scan” button 8C for selecting the scan function are displayed on the home screen 30B. The navigation bar 9 displays, for example, the name of a user who has been authenticated, such as “user A”, the name of a screen being displayed on the operation panel 15, such as “home”, and information for notifying the user that the operation panel 15 is in a contactless operation mode, such as “Touch Less”.

In response to the user holding their finger over the “Copy” button 8A, the “Copy” button 8A is selected. Upon selection of the “Copy” button 8A, a copy screen 30D is displayed on the operation panel 15.

The copy screen 30D displays buttons 8D to 8G for setting copy conditions, and a copy start button 8H for starting copying under the set copy conditions.

The copy screen 30D illustrated in FIG. 5 displays, as an example of the buttons 8 for setting copy conditions, for example, a color mode button 8D for selecting a copy color, a duplex/simplex selection button 8E for selecting a double-sided (duplex) or single-sided (simplex) copy mode, an N-up button 8F for selecting an image layout on a recording medium, and a number-of-copies button 8G for selecting the number of copies to be made.

In response to the user holding their finger over any one of the buttons 8D to 8G for setting the respective copy conditions, the button 8 corresponding to the operation position 6 of the user is selected, and the screen 30 for setting the copy condition corresponding to the selected button 8 is displayed.

In response to the duplex/simplex selection button 8E being selected on the copy screen 30D, a duplex/simplex selection screen 30G for selecting a duplex or simplex copy mode is displayed on the operation panel 15 in such a manner as to be superimposed on the copy screen 30D.

The duplex/simplex selection screen 30G illustrated in FIG. 5 displays, for example, a duplex-to-duplex selection button 8S for sequentially copying two-sided documents 11 on both sides of recording media, a simplex-to-duplex selection button 8T for sequentially copying one-sided documents 11 having text and the like on either side thereof on both sides of recording media, and a simplex-to-simplex selection button 8U for sequentially copying one-sided documents 11 having text and the like on either side thereof on either side of recording media.

In response to the user holding their finger over any one of the buttons 8S to 8U on the duplex/simplex selection screen 30G, the button 8 corresponding to the operation position 6 of the user is selected, and a copy mode corresponding to the selected button 8 is set. In the example of the duplex/simplex selection screen 30G illustrated in FIG. 5, the duplex-to-duplex selection button 8S is selected by the user.

In response to a duplex or simplex copy mode being set on the duplex/simplex selection screen 30G, the copy screen 30D is displayed on the operation panel 15. After the setting of the copy mode, the copy mode selected on the duplex/simplex selection screen 30G is displayed in the duplex/simplex selection button 8E on the copy screen 30D.

In the example described above, the user selects the duplex/simplex selection button 8E on the copy screen 30D. Also in response to the user selecting any one of the color mode button 8D, the N-up button 8F, and the number-of-copies button 8G on the copy screen 30D, a selection screen for selecting a copy condition corresponding to the selected one of the buttons 8 is displayed on the operation panel 15 in a manner similar to that for the duplex/simplex selection screen 30G.

In response to the user holding their finger over the copy start button 8H on the copy screen 30D, the copy start button 8H is selected. Upon selection of the copy start button 8H, a copying process for copying the content of the documents 11 on a recording medium is executed in accordance with the set copy conditions.

Before the setting of the copy conditions, the buttons 8D to 8G on the copy screen 30D display initially set copy conditions that are set in advance.

In response to the user holding their finger over the “Print” button 8B of the home screen 30B, the “Print” button 8B is selected. Upon selection of the “Print” button 8B, a print screen 30E is displayed on the operation panel 15.

The print screen 30E displays print information buttons 8J each for displaying information on a piece of image data to be used for printing, and an all-print start button 8M for starting printing of all of the pieces of image data corresponding to the respective print information buttons 8J. In the example of the print screen 30E illustrated in FIG. 5, the print screen 30E in which two pieces of image data to be used for printing are accepted is illustrated. That is, the print screen 30E displays a number of print information buttons 8J equal to the number of pieces of image data accepted as targets for printing from the user, each print information button 8J corresponding to a corresponding one of the pieces of image data.

If the number of pieces of image data is too large to display the corresponding print information buttons 8J in the print screen 30E at the same time, in response to the user performing a gesture of moving their finger in an upward/downward direction of the print information buttons 8J, the operation panel 15 detects the movement of the operation position 6 and scrolls the print information buttons 8J. As a result, the print information buttons 8J that are not displayed in the print screen 30E are displayed in the print screen 30E. The scroll operation may be implemented in response to the user selecting a movement button (not illustrated) for moving up or down the display of operation objects such as the print information buttons 8J in the screen 30.

Each of the print information buttons 8J displays a file name of image data to be used for printing and print conditions set by the user in advance for the image data. For example, when the user transmits image data from the terminal 4 to the image processing apparatus 10, print conditions set by the user using the terminal 4 are displayed in the print information button 8J.

In response to the user holding their finger over the all-print start button 8M, the all-print start button 8M is selected. Upon selection of the all-print start button 8M, a printing process for printing images represented by image data on recording media is executed in accordance with the set print conditions.

In response to the user holding their finger over any one of the print information buttons 8J, the print information button 8J over which the finger is held is selected. Upon selection of any one of the print information buttons 8J, a print edit screen 30H is displayed on the operation panel 15. The print edit screen 30H illustrated in FIG. 5 is displayed, for example, in response to the user selecting the print information button 8J corresponding to the image data representing “Material B.pdf”.

The print edit screen 30H displays, for example, a delete button 8V for deleting the image data corresponding to the selected print information button 8J, a change button 8W for changing a print condition of the image data corresponding to the selected print information button 8J, and an individual-print start button 8X for printing only the image data corresponding to the selected print information button 8J. The print edit screen 30H illustrated in FIG. 5 displays, as an example of the change button 8W, a change button 8W for changing the number of copies to be printed. The print edit screen 30H also displays, for example, a change button 8W (not illustrated) for changing any other print condition, such as the color of an image to be printed.

In response to the user holding their finger over the “Scan” button 8C of the home screen 30B, the “Scan” button 8C is selected. Upon selection of the “Scan” button 8C, a scan screen 30F is displayed on the operation panel 15.

The scan screen 30F displays scan setting buttons 8N for setting scan conditions, and a scan start button 8R for starting reading of the documents 11 in accordance with the set scan conditions.

In response to the user holding their finger over any one of the scan setting buttons 8N, the scan setting button 8N corresponding to the operation position 6 of the user is selected, and a selection screen (not illustrated) for selecting the scan condition corresponding to the selected scan setting button 8N is displayed. That is, the user sets each of the scan conditions associated with the scan setting buttons 8N in the same manner as the operation of setting the copy conditions through the copy screen 30D.

In response to the user holding their finger over the scan start button 8R, the scan start button 8R is selected. Upon selection of the scan start button 8R, a scanning process for converting the content of the documents 11 into image data is executed in accordance with the set scan conditions.

In response to the user holding their finger over the navigation bar 9 of the home screen 30B, the navigation bar 9 is selected. Upon selection of the navigation bar 9, a logout process of the authenticated user is performed, and the navigation bar 9 displays an indication of completion of the logout process (see a screen 30C)

The user may perform a predetermined gesture such as flicking their finger from right to left over the operation panel 15 or select a “return button” (not illustrated) displayed on the screen 30 to return from each of the screens 30 being displayed on the operation panel 15 to the previous screen 30.

In the example described above, any one of the buttons 8 is selected in response to the user holding their finger over the button 8. In a contactless operation, the user’s finger may shake because the finger is not in contact with the operation panel 15. If an operation object whose display area includes the operation position 6 is simply set as an operation object selected by the user because the display area includes the operation position 6, another operation object adjacent to the operation object that the user is intended to operate may be incorrectly selected, which may occur from unintended shaking of the finger. In addition, the user may pass their finger over another operation object not to be operated while moving the finger to above the operation object to be operated, and the unintended operation object may be incorrectly selected.

Accordingly, it is desirable that when the user continuously holds their finger over an operation object for a predetermined period of time, the operation object over which the finger is held is determined to be an operation object intentionally selected by the user. In other words, when the operation position 6 of the user remains located in a display area of a specific operation object on the operation panel 15 for a predetermined period of time, it is determined that the user has selected the operation object. In this exemplary embodiment, the predetermined period of time is 3 seconds. However, this example is not limiting. For example, the predetermined period of time may be set to a time other than 3 seconds. The method for detecting the operation position 6 is not limited to a detection method using the operation panel 15, which is a capacitive touch panel. For example, the operation position 6 may be detected using a time-of-flight (ToF) camera or the like.

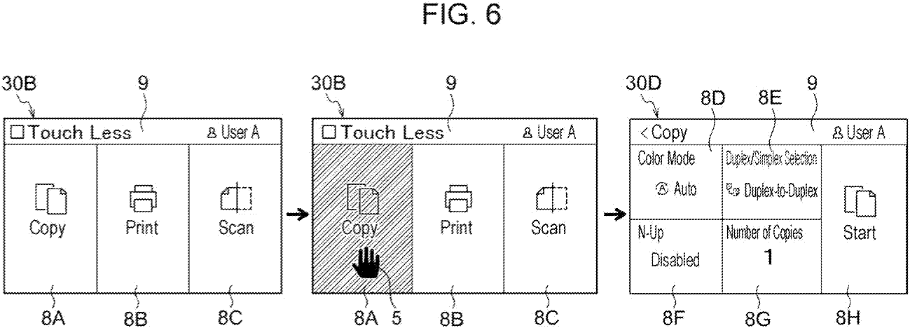

FIG. 6 illustrates an example selection in which the user selects the “Copy” button 8A, which is an example of an operation object, on the home screen 30B.

In response to the user holding their finger over the “Copy” button 8A, the operation position 6 is detected within the display area of the “Copy” button 8A. Such a transition from a state in which the operation position 6 has not been detected within a display area of an operation object to a state in which the operation position 6 has been detected within the display area of the operation object is referred to as “selection start” or “hovering”. While an operation object is in the selection start state, the operation object has not yet been selected.

When the user continuously holds their finger over the “Copy” button 8A and the detected operation position 6 remains located within the display area of the “Copy” button 8A for a predetermined period of time, as illustrated in FIG. 6, the “Copy” button 8A is selected, and the copy screen 30D is displayed on the operation panel 15. The confirmation of selection of an operation object is referred to as “selection completion” or “holding”. The completion of selection of an operation object is referred to as the operation object having been selected.

Accordingly, in response to the user’s finger moving from over the “Copy” button 8A to another location during selection start, the selection start for the “Copy” button 8A is released. Such movement of the user’s finger from over an operation object to another location during selection start is referred to as “deselection”. After an operation object is deselected, if the user again continuously holds their finger over the deselected operation object for a predetermined period of time, the selection of the deselected operation object is completed. The predetermined period of time taken from selection start to selection completion is hereinafter referred to as a “confirmation time”.

Each of the operation objects in the screens 30 is associated in advance with a process to be executed in response to the selection of the operation object such that a copying process is executed in response to selection of the copy start button 8H. To notify the user of the processes to be executed for the respective operation objects, each of the operation objects displays, for example, information indicating the content of the process to be executed in response to the selection of the operation object, such as “start” for the copy start button 8H. The user understands a process associated with each of the operation objects by checking information indicating the content of the process to be executed in response to the selection of the operation object, that is, by checking an item associated with the operation object. As described above, the operation objects are displayed on the screens 30 in such a manner as to be associated with items each indicating the content to be processed. Accordingly, each of the operation objects is an example of an “item displayed on a screen” according to this exemplary embodiment.

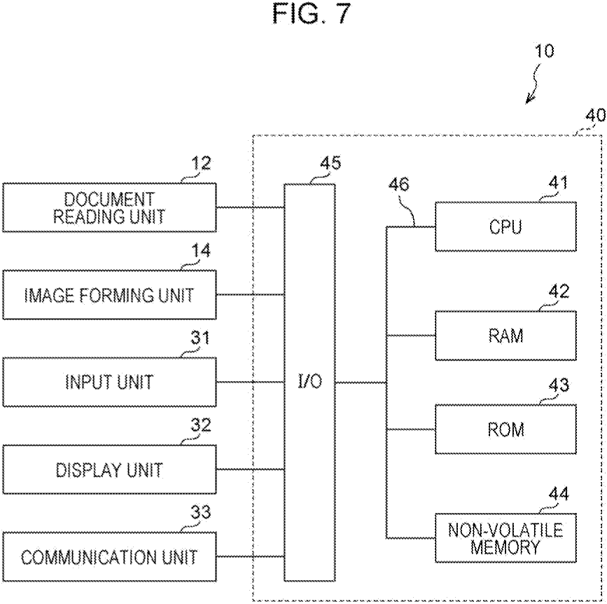

Next, the configuration of the substantial part of an electric system of the image processing apparatus 10 will be described with reference to FIG. 7. The image processing apparatus 10 is implemented using, for example, a computer 40.

In the computer 40, a central processing unit (CPU) 41, a random access memory (RAM) 42, a read only memory (ROM) 43, a non-volatile memory 44, and an input/output interface (I/O) 45 are connected to each other via a bus 46.

The CPU 41 is an example of a processor configured to perform processing of the functional sections of the image processing apparatus 10 illustrated in FIG. 4. The RAM 42 is an example of a storage medium to be used as a temporary work area for the CPU 41. The ROM 43 is an example of a storage medium that stores an information processing program to be executed by the CPU 41. The non-volatile memory 44 is an example of a storage medium configured such that information stored therein is maintained even if power supply to the non-volatile memory 44 is shut off. Examples of the non-volatile memory 44 include a semiconductor memory and a hard disk. The non-volatile memory 44 is not necessarily incorporated in the computer 40, and may be, for example, a storage medium attachable to the computer 40 in a removable manner, such as a memory card.

The I/O 45 is connected to, for example, the document reading unit 12, the image forming unit 14, an input unit 31, a display unit 32, and a communication unit 33.

The document reading unit 12 and the image forming unit 14 are devices that perform operations as described above.

The input unit 31 is a device that notifies the CPU 41 of an instruction from the user and a user ID of the user in response to receipt of the instruction and the user ID. Examples of the input unit 31 include a touch panel constituting the operation panel 15, and the reader device 17.

The display unit 32 is a device that visually displays information processed by the CPU 41. Examples of the display unit 32 include a display constituting the operation panel 15.

The communication unit 33 is connected to the communication line 2 and has a communication protocol for communicating with the terminals 4.

The units connectable to the I/O 45 are not limited to the units illustrated in FIG. 7. The I/O 45 may be connected to a unit necessary for implementing a function in accordance with the functions of the image processing apparatus 10.

### First Exemplary Embodiment

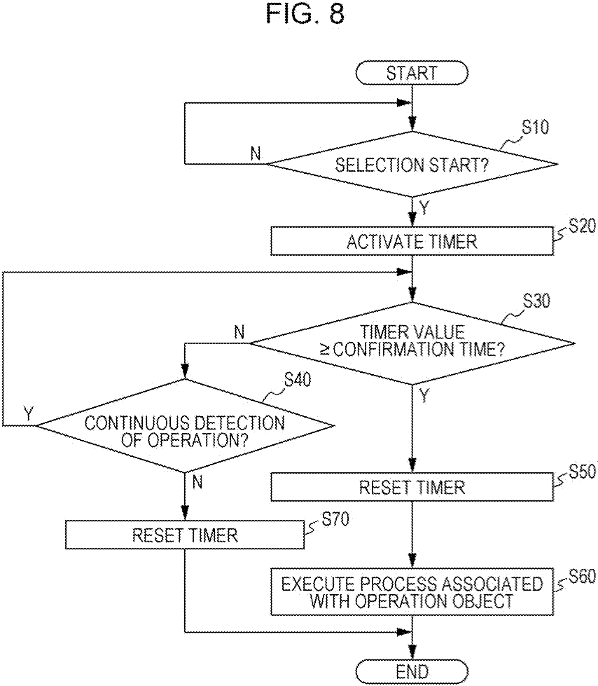

Next, the operation of the image processing apparatus 10 according to a first exemplary embodiment will be described. FIG. 8 is a flowchart illustrating an example of the flow of an operation process performed by the CPU 41 in response to the user performing a contactless operation on a screen 30 displayed on the operation panel 15. An information processing program that defines the operation process is stored in advance in, for example, the ROM 43 of the image processing apparatus 10. The CPU 41 of the image processing apparatus 10 reads the information processing program stored in the ROM 43 and executes the operation process.

A confirmation time is set in advance for each of the operation objects, and a confirmation time for at least one of the operation objects is set to be different from those for the other operation objects.

First, in step S10, the CPU 41 determines whether any of the operation objects displayed on the screen 30 has entered the selection start state. If none of the operation objects has entered the selection start state, the determination processing of step S10 is repeatedly executed until any of the operation objects has entered the selection start state. If any of the operation objects has entered the selection start state, the process proceeds to step S20.

In step S20, the CPU 41 activates a timer using, for example, a timer function incorporated in the CPU 41. When no timer function is incorporated in the CPU 41, for example, the CPU 41 controls a timer unit connected to the I/O 45 to activate a timer.

In step S30, the CPU 41 determines whether the time measured by the timer activated in step S20 has reached the confirmation time set for the operation object brought into the selection start state. If the time measured by the timer has not reached the confirmation time, the process proceeds to step S40.

In step S40, the CPU 41 determines whether the operation position 6 of the user is being continuously detected within the display area of the operation object determined to have entered the selection start state in step S10. If the operation position 6 of the user is being continuously detected within the display area of the operation object that is in the selection start state, the process returns to step S30, and the CPU 41 again determines whether the time measured by the timer has reached the confirmation time. That is, the CPU 41 determines whether the user keeps holding their finger over the same operation object until the confirmation time elapses after the start of the operation performed by the user is detected.

If the user moves their finger from over the operation object before the confirmation time is reached, this means that the operation object in the selection start state is not an operation object to be intentionally selected by the user. Accordingly, if it is determined in the determination processing of step S40 that the operation position 6 of the user is no longer detected within the display area of the operation object determined to have entered the selection start state in step S10, the process proceeds to step S70.

In this case, to deselect the operation object, in step S70, the CPU 41 resets the timer activated in step S20, and then the operation process illustrated in FIG. 8 ends. The phrase “resetting the timer” refers to stopping the timer and returning the time measured by the timer to 0 seconds.

On the other hand, if it is determined in the determination processing of step S30 that the time measured by the timer has reached the confirmation time, that is, if the user continuously holds their finger over the same operation object until the confirmation time elapses after the operation object has been brought into the selection start state, the process proceeds to step S50.

In this case, the selection of the operation object determined to have entered the selection start state in step S10 is confirmed and the operation object has entered the selection completion state. Thus, in step S50, the CPU 41 resets the timer activated in step S20.

Then, in step S60, the CPU 41 executes a process associated in advance with the operation object brought into selection completion. Then, the operation process illustrated in FIG. 8 ends.

If the confirmation time set for the operation object brought into selection completion is shorter than those for the other operation objects, the user is able to select the operation object to be operated in a shorter time than those for the other operation objects. That is, an operation object for which a confirmation time shorter than those for the other operation objects is set is an example of a “first item” according to this exemplary embodiment, and an operation object for which a confirmation time longer than those for the other operation objects is an example of a “second item” according to this exemplary embodiment.

In the example described above, a shorter confirmation time is set for an operation object selected by the user than those for the other operation objects. It is desirable that the length of the confirmation time to be set for an operation object is set in accordance with the type of the operation object.

The operation objects include, for example, an operation object for providing an instruction to implement a function associated in advance with the operation object in response to the selection of the operation object being confirmed, such as the copy start button 8H, the all-print start button 8M, the individual-print start button 8X, and the scan start button 8R illustrated in FIG. 5. The phrase “providing an instruction to implement a function” means that the CPU 41 drives at least one of the document reading unit 12 or the image forming unit 14 and instructs the driven unit(s) to execute a process involving operations such as transporting each of the documents 11 and forming an image on a recording medium, for example.

The operation objects also include, for example, an operation object for setting an operation condition of a function associated in advance with the operation object in response to the selection of the operation object being confirmed, such as the color mode button 8D and the duplex/simplex selection button 8E on the copy screen 30D illustrated in FIG. 5. The phrase “setting an operation condition of a function” means that the CPU 41 stores operation conditions for the document reading unit 12 and the image forming unit 14 in a storage medium such as the RAM 42 without activating any of the document reading unit 12 and the image forming unit 14. In other words, the phrase “setting an operation condition of a function” refers to executing a process involving no physical operation.

For example, the user intended to select a specific operation object may make the mistake of selecting an adjacent operation object because their finger shakes, and an operation object different from the operation object to be selected may be brought into selection completion. If the operation object incorrectly brought into selection completion is an operation object for setting an operation condition of a function, the user is able to set a desired operation condition by canceling the process to be executed by the operation object incorrectly brought into selection completion and re-selecting the intended operation object to be selected. However, if the operation object incorrectly brought into selection completion is an operation object for providing an instruction to implement a function, a process (e.g., a copying process) involving an operation associated with the operation object brought into selection completion may be started.

Accordingly, to make it less likely that, even if the user makes the mistake of starting the selection of an operation object for providing an instruction to implement a function, the selection of the operation object is completed than when the selection of an operation object for setting an operation condition of a function is started, a confirmation time for the operation object for providing an instruction to implement a function is preferably set to be longer than a confirmation time for the operation object for setting an operation condition of a function. Since a confirmation time for the operation object for setting an operation condition of a function is set to be shorter than a confirmation time for the operation object for providing an instruction to implement a function, the time taken to set the operation condition of the function is reduced as compared with a case where a confirmation time for each operation object is set to be equal to the confirmation time set for the operation object for providing an instruction to implement a function.

In the example described above, the length of the confirmation time set for each operation object is set in accordance with the type of the operation object. However, the factor for determining the confirmation time to be set for each operation object is not limited to this. For example, the CPU 41 may set a confirmation time for each operation object in accordance with the size of the display area of the operation object displayed on the screen 30.

For example, an operation object associated with a process having a higher degree of importance than the other operation objects and an operation object associated with a process having a higher frequency of operation than the other operation objects may be displayed larger than the other operation objects on the screen 30. For example, on the copy screen 30D illustrated in FIG. 6, the copy start button 8H having a higher frequency of operation than the other buttons 8 is displayed larger than the color mode button 8D, the duplex/simplex selection button 8E, the N-up button 8F, and the number-of-copies button 8G.

Accordingly, the CPU 41 may set a confirmation time for an operation object such that the confirmation time for the operation object increases as the size of the display area of the operation object on the screen 30 increases, and set a confirmation time for an operation object such that the confirmation time for the operation object decreases as the size of the display area of the operation object on the screen 30 decreases. It is to be understood that the CPU 41 may set a confirmation time for an operation object such that the relationship between the size of the display area of the operation object and the length of the confirmation time for the operation object becomes opposite to that described above.

In some cases, an operation object associated with a process having a higher degree of importance than the other operation objects and an operation object associated with a process having a higher frequency of operation than the other operation objects may be set such that the outline of each of the operation objects is bold or text representing an item associated with each of the operation objects (referred to as the “caption of the operation object”) is bold even if the display areas of these operation objects have the same size.

Accordingly, the CPU 41 may set a confirmation time for an operation object such that the confirmation time for the operation object increases as at least one of the outline and the caption of the operation object increases in thickness and such that the confirmation time for the operation object decreases as at least one of the outline and the caption of the operation object decreases in thickness. It is to be understood that the CPU 41 may set a confirmation time for an operation object such that the relationship between the thickness of at least one of the outline and the caption of the operation object and the length of the confirmation time for the operation object becomes opposite to that described above. Additionally, when the operation panel 15 supports color display, the CPU 41 may set a confirmation time for an operation object in accordance with the display color of the operation object.

Information related to the attributes of operation objects on each of the screens 30, such as the types of the operation objects, the sizes of the display areas of the operation objects, the thicknesses of the outlines of the operation objects, the thicknesses of the captions of the operation objects, and the display colors of the operation objects, is stored in the non-volatile memory 44 in advance, for example. Accordingly, the CPU 41 acquires the information related to the attributes of operation objects on each of the screens 30 from the non-volatile memory 44 and sets a confirmation time for each of the operation objects. The CPU 41 may set a confirmation time for an operation object by combining at least two of the type of the operation object, the size of the display area of the operation object, or information related to the attributes of the operation object.

In the example described above, operation objects are classified into a group of operation objects each for providing an instruction to implement a function and a group of operation objects each for setting an operation condition of a function, and a different confirmation time is set for each of the groups. However, the classification of operation objects for which different confirmation times are preferably set is not limited to this example.

For example, if an operation object for which money is charged in response to selection of the operation object is incorrectly brought into selection completion, unexpected money may be charged. It is therefore desirable that the confirmation time set for an operation object for which money is charged in response to selection completion of the operation object is longer than the confirmation time set for an operation object for which no money is charged in response to selection completion of the operation object.

For example, money may be charged for copying and printing that consume paper, whereas no money may be charged for scanning that does not consume paper. In this case, the confirmation times for the copy start button 8H, the all-print start button 8M, and the individual-print start button 8X are set to be longer than the confirmation time for the scan start button 8R even if all of them are operation objects each for providing an instruction to implement a function. When the image processing apparatus 10 has a function of performing facsimile (fax) transmission, the confirmation time for a fax transmission button (not illustrated) is set to be longer than the confirmation time for the scan start button 8R since money is to be charged for fax transmission.

In addition, if an operation object that transmits data to an apparatus (referred to as an “external apparatus”) different from the image processing apparatus 10 in response to selection of the operation object is incorrectly brought into selection completion, a security issue may arise. Accordingly, it is desirable that the confirmation time set for an operation object that transmits data to an external apparatus in response to selection completion of the operation object is longer than the confirmation time set for an operation object that does not transmit data to an external apparatus in response to selection completion of the operation object.

For example, fax transmission transmits data to the outside of the image processing apparatus 10. In this case, the confirmation time for the fax transmission button (not illustrated) is set to be longer than the confirmation times for the copy start button 8H, the all-print start button 8M, the individual-print start button 8X, and the scan start button 8R even if all of them are operation objects each for providing an instruction to implement a function. Some types of image processing apparatuses 10 have a function of converting an image acquired by scanning, printing, or copying into data and transmitting the data to an external apparatus. In this case, it is desirable that the confirmation times for the copy start button 8H, the all-print start button 8M, the individual-print start button 8X, and the scan start button 8R are set to be longer than a predetermined confirmation time. Alternatively, the confirmation time for even an operation object that transmits data to an external apparatus in response to selection completion of the operation object may be set to be equal to the confirmation time for an operation object that does not transmit data to an external apparatus in response to selection completion of the operation object if data is to be transmitted from such an operation object that transmits data to an external apparatus installed in a range (e.g., a company) determined in advance as a reliable location.

In a case where operation conditions of functions are hierarchically set, the number of screens 30 to which transitions are made until the screen 30 for setting an operation condition of a specific function (referred to as the “target screen 30”, for convenience of description) is displayed may be large. When screen transitions are made such that upon setting of an operation condition of a function on the target screen 30, the previous screen 30 does not appear, but the screen 30 that follows the route of the hierarchy appears, if an operation object for setting an operation condition of a function on the target screen 30 is incorrectly brought into selection completion, the amount of operation to be performed until the target screen 30 is displayed again to correct the operation condition increases in accordance with the depth of the hierarchy. Accordingly, confirmation times for operation objects on each of the screens 30 are set to increase as the depth of the hierarchy of the screens 30 increases, thereby preventing or reducing the occurrence of a situation in which an operation object is brought into selection completion in response to incorrect operation and the screen 30 that follows the route of the hierarchy appears.

For example, the CPU 41 may adjust a confirmation time set for an operation object in accordance with the manner of the operation of the user. Specifically, the CPU 41 adjusts the confirmation time for the operation object corresponding to the operation position 6 in accordance with the operation distance D illustrated in FIG. 3A.

For convenience of description, the confirmation time set in advance for each of the operation objects may be referred to as a “reference confirmation time”.

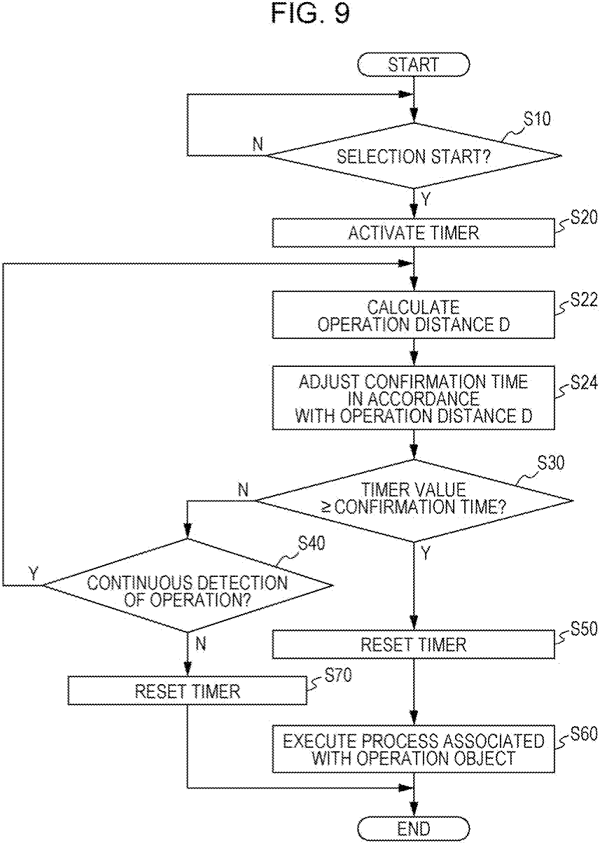

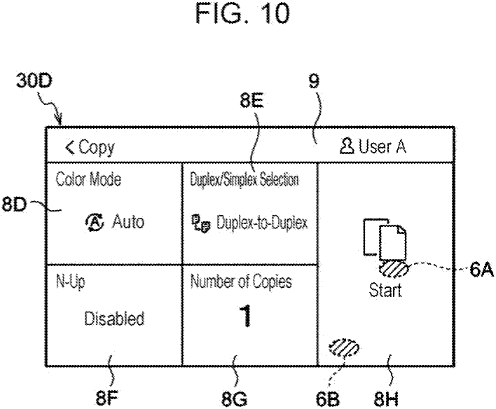

FIG. 9 is a flowchart illustrating an example of the flow of an operation process for adjusting a confirmation time for an operation object in accordance with the manner of the operation of the user. An information processing program that defines the operation process is stored in advance in, for example, the ROM 43 of the image processing apparatus 10. The CPU 41 of the image processing apparatus 10 reads the information processing program stored in the ROM 43 and executes the operation process.

The operation process illustrated in FIG. 9 is different from the operation process illustrated in FIG. 8 in that steps S22 and S24 are added, and the other processing operations are the same as those in the operation process illustrated in FIG. 8. The operation process illustrated in FIG. 9 will be described hereinafter with a focus on the differences from the operation process illustrated in FIG. 8.

After the CPU 41 activates a timer in step S20 in response to the selection start state of any of the operation objects, the process proceeds to step S22.

In step S22, the CPU 41 calculates the operation distance D from the amount of change in electrostatic capacitance on the operation panel 15 at the operation position 6 of the user.

In step S24, the CPU 41 compares the operation distance D calculated in step S22 with the reference operation distance for the operation object corresponding to the operation position 6 to adjust the confirmation time for the operation object corresponding to the operation position 6. Specifically, the CPU 41 multiplies the reference confirmation time for the operation object corresponding to the operation position 6 by the ratio of the operation distance D to the reference operation distance for the operation object to adjust the confirmation time for the operation object.

That is, the CPU 41 adjusts the confirmation time for the operation object corresponding to the operation position 6 to be shorter than the reference confirmation time as the operation distance D becomes shorter than the reference operation distance, and adjusts the confirmation time for the operation object corresponding to the operation position 6 to be longer than the reference confirmation time as the operation distance D becomes longer than the reference operation distance.

To complete the selection of an operation object as quickly as possible in the image processing apparatus 10 that executes the operation process illustrated in FIG. 9, the user performs an operation of bringing their finger as close as possible to the operation panel 15. That is, even if the reference confirmation times for the respective operation objects are the same, a confirmation time for an operation object for which selection is started is adjusted in accordance with the user’s operation method.

The CPU 41 does not need to make the confirmation time corresponding to the operation distance D at the operation object proportional to the operation distance D, and may adjust the confirmation time to be non-linear. Instead of calculating the confirmation time for the operation object using an arithmetic expression with the reference confirmation time and the operation distance D as explanatory variables and the confirmation time as an objective variables, the CPU 41 may refer to a table in which the operation distance D and the confirmation time are associated with each other to acquire the confirmation time corresponding to the operation distance D.

In the operation process illustrated in FIG. 9, the confirmation time for the operation object is adjusted in accordance with the operation distance D, by way of example. However, the adjustment of the response speed of the operation panel 15 in response to an operation of the user in accordance with the operation distance D is not limited to this example.

For example, the CPU 41 may adjust the response speed of the operation panel 15 in accordance with the degree of change in the operation distance D per unit time. Specifically, the CPU 41 may shorten the confirmation time set in advance for the operation object to be operated as the degree of change in the operation distance D per unit time in a direction toward the operation object increases. The degree of change in the operation distance D per unit time in the direction toward the operation object is also referred to as the “degree of pushing”. That is, the CPU 41 detects an operation of the user pushing an operation object with their finger, and adjusts the response speed of the operation panel 15 in accordance with the degree of pushing.

For example, the copy screen 30D illustrated in FIG. 6 includes the number-of-copies button 8G for selecting the number of copies to be made. Examples of the method for selecting the number of copies may include an operation method for setting the desired number of copies with up and down arrow buttons in a spin box such that the user operates an operation object (up arrow button) for increasing the number of copies by one and an operation object (down arrow button) for decreasing the number of copies by one. When the operation process illustrated in FIG. 9 is applied to the up and down arrow buttons, the speed of increase in the number of copies increases as the user brings their finger closer to the up arrow button for increasing the number of copies by one. As the user brings their finger closer to the down arrow button for decreasing the number of copies by one, the speed of decrease in the number of copies increases.

Using the operation distance D, it is possible to increase and decrease the number of copies with a single operation object. For example, when the user holds their finger over the operation object so that the operation distance D is shorter than the reference operation distance, the CPU 41 increases the number of copies by one. When the user holds their finger over the operation object so that the operation distance D is longer than the reference operation distance, the CPU 41 decreases the number of copies by one. In this case, the CPU 41 may change the speed of increase or decrease in the number of copies in accordance with the operation distance D. For example, the CPU 41 increases the speed of increase or decrease in the number of copies as the distance from the reference operation distance to the operation distance D increases.

While an operation of increasing and decreasing a set value using an example of setting the number of copies has been described, it is to be understood that the operation of increasing and decreasing a set value described above may be applied not only to an operation object for setting the number of copies but also to an operation object for setting some numerical value.

Various methods for adjusting a confirmation time in accordance with the manner of the operation of the user, including an example method for adjusting a confirmation time for an operation object in accordance with the operation distance D, are available.

For example, the CPU 41 may adjust the confirmation time for the operation object corresponding to the operation position 6 in accordance with the location of the operation position 6 in the display area of the operation object, that is, in accordance with which position of the operation object the user has operated.

Specifically, the CPU 41 sets the confirmation time for the copy start button 8H to be shorter as the operation position 6 approaches the center of the display area of the copy start button 8H, and sets the confirmation time for the copy start button 8H to be longer as the operation position 6 approaches the outline of the display area of the copy start button 8H.

FIG. 10 illustrates an example of the operation position 6 detected at the copy start button 8H on the copy screen 30D. The operation position 6 detected at the copy start button 8H includes an operation position 6B and an operation position 6A that is closer to the center of the copy start button 8H than the operation position 6B. As a result, the confirmation time for the copy start button 8H is shorter when the user holds their finger over the copy start button 8H at the position corresponding to the operation position 6A than when the user holds their finger over the copy start button 8H at the position corresponding to the operation position 6B.

The center of the display area of an operation object refers to, for example, the center of gravity of the operation object. The center of the display area of a rectangular operation object such as the copy start button 8H is the point of intersection of diagonal lines of the operation object. However, the CPU 41 may use a location set in advance by the user as the center of the display area of the operation object.

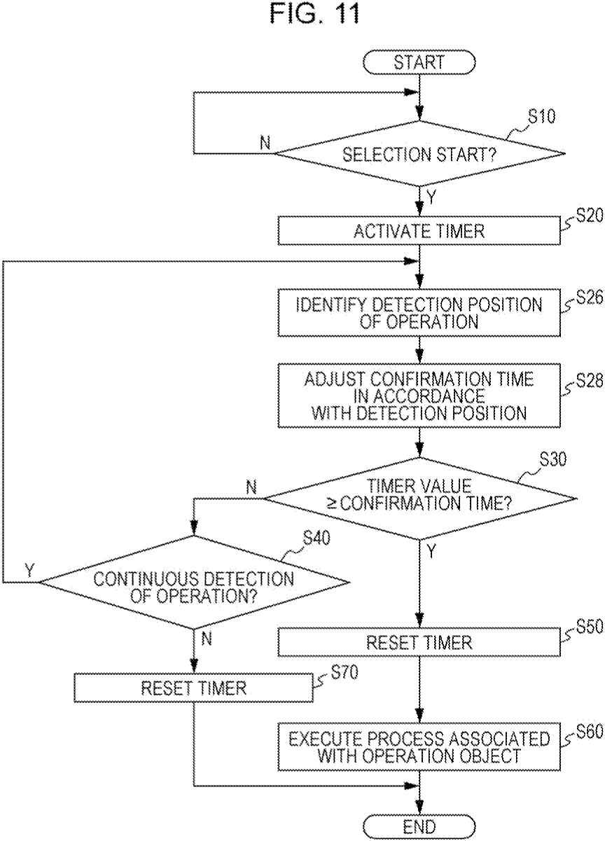

FIG. 11 is a flowchart illustrating an example of the flow of an operation process for adjusting a confirmation time for an operation object in accordance with the detection position of an operation in the display area of the operation object. An information processing program that defines the operation process is stored in advance in, for example, the ROM 43 of the image processing apparatus 10. The CPU 41 of the image processing apparatus 10 reads the information processing program stored in the ROM 43 and executes the operation process.

The operation process illustrated in FIG. 11 is different from the operation process illustrated in FIG. 9 in that steps S22 and S24 in FIG. 9 are replaced with steps S26 and S28, respectively, and the other processing operations are the same as those in the operation process illustrated in FIG. 9. The operation process illustrated in FIG. 11 will be described hereinafter with a focus on the differences from the operation process illustrated in FIG. 9.

After the CPU 41 activates a timer in step S20 in response to the selection start state of any of the operation objects, the process proceeds to step S26.

In step S26, the CPU 41 compares the coordinate point corresponding to the operation position 6 output from the operation panel 15 with coordinate information indicating the display area of the operation object in the screen 30, and identifies the detection position of an operation in the display area of the operation object.

In step S28, the CPU 41 adjusts the confirmation time for the operation object corresponding to the operation position 6 in accordance with the distance (referred to as the “detection distance of the operation position 6”) from the detection position of the operation identified in step S26 to the center of the operation object corresponding to the operation position 6. Specifically, the CPU 41 multiplies the reference confirmation time for the operation object corresponding to the operation position 6 by the ratio of the detection distance of the operation position 6 to a reference detection distance set in advance for the operation object to set the confirmation time for the operation object.

That is, the CPU 41 sets the confirmation time for the operation object corresponding to the operation position 6 to be shorter as the detection distance of the operation position 6 becomes shorter than the reference detection distance, and sets the confirmation time for the operation object corresponding to the operation position 6 to be longer as the detection distance of the operation position 6 becomes longer than the reference detection distance. When the detection distance of the operation position 6 is equal to the reference detection distance, the CPU 41 sets the confirmation time for the operation object corresponding to the operation position 6 as the reference confirmation time.

It is to be understood that the CPU 41 may set a confirmation time for an operation object such that the relationship between the detection distance of the operation position 6 and the length of the confirmation time for the operation object corresponding to the operation position 6 becomes opposite to that described above.

When the display area of the operation object is smaller than the size of the user’s finger, it may be difficult for the user to perform an operation of bringing the position over which the user holds their finger close to the center of the operation object or close to the outline of the operation object. Accordingly, the CPU 41 may control the operation panel 15 to display the display area of the operation object brought into the selection start state on the screen 30 after enlarging the display area of the operation object to be larger than the display area of the operation object before being brought into selection start. After the selection of the operation object is completed, the CPU 41 controls the operation panel 15 to return the size of the enlarged display area of the operation object to the size of the display area of the operation object before being brought into selection start and then display the display area of the operation object on the screen 30. As a result, as compared with a case where the size of the display area of the operation object is not changed even after the selection of the operation object is started, the user’s operability in adjusting the confirmation time in response to a change in the operation position 6 of the operation object may be improved.

Further, the CPU 41 may set the confirmation time for the operation object corresponding to the operation position 6 in accordance with the size of the range of the position on the operation panel 15 corresponding to the operation position 6.

FIG. 12 illustrates an example of the operation position 6 detected at the copy start button 8H on the copy screen 30D. An operation position 6A' indicates, for example, the operation position 6 when the user holds their two fingers over the copy start button 8H. An operation position 6B' indicates, for example, the operation position 6 when the user holds their one finger over the copy start button 8H. In this case, the range over which the electrostatic capacitance changes on the operation panel 15 changes in accordance with the size of the living body (the finger or fingers in the example described above) held over the operation panel 15. The range of the operation position 6A is thus larger than the range of the operation position 6B.

In response to detection of the operation position 6, the operation panel 15 outputs information related to the size of the range of the detected operation position 6. The information related to the size of the range of the detected operation position 6 includes, for example, information related to a circumcircle circumscribing the range of the detected operation position 6 or information related to the size of a rectangle or a square circumscribing the range of the detected operation position 6. Specifically, the information related to the size of the range of the detected operation position 6 includes, for example, the radius of the circumcircle or the coordinate points of the vertices of the rectangle.

The CPU 41 may use the information related to the size of the range of the operation position 6 to set, for example, the confirmation time for the operation object corresponding to the operation position 6 to become shorter than the reference confirmation time as the range of the operation position 6 detected on the operation panel 15 becomes larger. The CPU 41 may set, for example, the confirmation time for the operation object corresponding to the operation position 6 to become longer than the reference confirmation time as the range of the operation position 6 detected on the operation panel 15 becomes smaller. When the size of the range of the operation position 6 is equal to a predetermined reference size, the CPU 41 sets the confirmation time for the operation object corresponding to the operation position 6 as the reference confirmation time.

It is to be understood that the CPU 41 may set a confirmation time for an operation object such that the relationship between the size of the range of the operation position 6 and the length of the confirmation time for the operation object corresponding to the operation position 6 becomes opposite to that described above. As described above, the CPU 41 may combine at least two of the operation distance D, the detection position of an operation, or the size of the range of the operation position 6 to adjust the confirmation time set in advance for an operation object.

The confirmation time set in advance for each operation object does not need to be identical for all registered users, and a different confirmation time may be set for each registered user. For example, the CPU 41 may set the confirmation time for the “Copy” button 8A to 1 second when a user A operates the “Copy” button 8A of the home screen 30B illustrated in FIG. 6, and set the confirmation time for the “Copy” button 8A to 1.5 seconds when a user B operates the “Copy” button 8A of the home screen 30B illustrated in FIG. 6. The confirmation time for each user, which is set for each operation object displayed on each of the screens 30, is stored in, for example, the non-volatile memory 44. The CPU 41 acquires, from the non-volatile memory 44, the confirmation time corresponding to the user represented by the user ID acquired in the authentication process, and sets in advance the confirmation time for an operation object displayed on the screen 30.

The confirmation time set in advance for each operation object may be set and changed by the user. When the user does not set a confirmation time in advance, the CPU 41 sets a confirmation time for each operation object.

For example, the CPU 41 refers to a standard confirmation time for each operation object, which is stored in the non-volatile memory 44 in advance, and sets the standard confirmation time for the corresponding operation object.

Alternatively, the CPU 41 may set a confirmation time for an operation object by using a use history, which is stored in the non-volatile memory 44 each time the user uses the image processing apparatus 10. The use history includes, for example, identification information for identifying the operation object selected by the user. Accordingly, the CPU 41 is capable of referring to the use history to acquire the frequency of selection for each operation object. The confirmation time set for the operation object is shortened as the frequency of selection for the operation object increases, thereby improving the user’s operability in the image processing apparatus 10, as compared with a case where the confirmation time set for the operation object is shortened as the frequency of selection for the operation object decreases.

An operation object having a higher frequency of selection than the other operation objects is typically an operation object that is more affected by an incorrect operation than the other operation objects, such as the button 8 for providing an instruction to start a process involving an operation such as a copying process, for example. Accordingly, the CPU 41 may lengthen the confirmation time set for the operation object as the frequency of selection for the operation object increases. In this case, as compared with a case where the confirmation time set for the operation object is shortened as the frequency of selection for the operation object increases, the number of times an operation object that is more affected by an incorrect operation than the other operation objects is incorrectly brought into to the selection completion state by the user may be reduced.

When setting a confirmation time for an operation object, for example, the CPU 41 sets a value (referred to as a “threshold value”) representing the length of the confirmation time as a numerical value to “2” when the confirmation time is 2 seconds. However, the CPU 41 may change the confirmation time for the operation object without changing the threshold value.

For example, a timer having a resolution of 1 second counts up by one every second to measure the time in real time. Accordingly, if the threshold value is “2”, the time taken for the timer to count up to “2” is 2 seconds. Such a measurement speed for counting up to the threshold value in a time equal to the confirmation time set for the operation object is referred to as a “reference measurement speed”.

When a timer that counts up by one every 0.5 seconds is used, the time taken for the timer to count up to “2” is 1 second even if the threshold value is also “2”.

As described above, the CPU 41 may change the measurement speed of the threshold value for the timer to adjust the confirmation time for the operation object corresponding to the operation position 6.

For example, to set the confirmation time for the operation object to be shorter than the reference confirmation time, the CPU 41 sets the measurement speed of the timer such that the measurement speed per count is shorter than the reference measurement speed. That is, to set the confirmation time for the operation object to be shorter than the reference confirmation time, the CPU 41 sets the timer such that the time measured per count of the threshold value is shorter than the time measured per count at the reference measurement speed.

Specifically, the CPU 41 selects a clock of a timer that affects the time measured per count from among a plurality of clocks having different frequencies to change the confirmation time for the operation object. The CPU 41 may select any one of a plurality of timers by which times measured per count are different to change the confirmation time for the operation object. Alternatively, the CPU 41 may adjust the confirmation time set for the operation object by adjusting the confirmation time in accordance with the manner of the operation of the user and further selecting the measurement speed of the threshold value for the timer.

### Second Exemplary Embodiment

Next, an exemplary embodiment for addressing an operation error in which a user who is to perform a contactless operation on an operation object with their finger performs an operation of selecting an unintended operation object because the finger shakes will be described.

Since the detection area above an operation object has the same size as the operation object, depending on the position of the user’s finger in the space, the finger may shake and accidentally enter an adjacent operation object. In this case, an unintended input to the adjacent operation object may be determined, and an input error may occur. The operation objects represent items to be operated, and include the “Copy” button 8A, the “Print” button 8B, the “Scan” button 8C, and the navigation bar 9 in the example of the home screen 30B illustrated in FIG. 5 described above.

In the image processing apparatus 10 according to this exemplary embodiment, accordingly, the detection area corresponding to an operation object displayed on the operation panel 15 is configured to have a smaller size than the operation object. That is, no detection area exists near the boundary between an operation object to be selected by the user and an operation object adjacent to the operation object. Thus, the user holds their finger over around the center of the operation object to select the operation object. This makes it less likely that the user’s finger accidentally enters an adjacent operation object even if the user’s finger slightly shakes, and prevents or reduces the occurrence of an input error.

The controller 20 according to this exemplary embodiment displays an image including one or more operation objects in the screen 30 on the operation panel 15. In response to detection of a contactless input to an operation object from the user, when the contactless input is accepted for a period of time equal to or longer than a predetermined period of time (threshold value) in a detection area smaller in size than the operation object, the controller 20 selects the operation object corresponding to the detection area, that is, confirms the selection of the operation object. The threshold value may be uniformly set regardless of the type of the operation object, or may be set to an appropriate value in accordance with the type of the operation object. The threshold value is set, for example, in the range of 1 second or more and 10 seconds or less (e.g., 3 seconds).

The detection area is an area in space and is not visible to the user. Accordingly, it is conceivable that the user uses an image (icon) and text displayed in the operation object as a guide and holds their finger over the image (icon) and the text. Thus, the detection area may be provided so as to correspond to an area including at least a portion of the image (icon) and the text displayed in the operation object. Specifically, in the example illustrated in FIG. 5 described above, the “Copy” button 8A displays an icon and text indicating copying, and a detection area of the “Copy” button 8A is provided so as to correspond to a circumscribed rectangle (a dotted line portion of the home screen 30B) circumscribing the icon and the text. In contrast, a detection area of the all-print start button 8M, which is provided so as to correspond to a circumscribed rectangle (a dotted line portion of the print screen 30E) circumscribing the icon and the text in a manner similar to that of the “Copy” button 8A, has a horizontally long shape. In this case, the detection area of the all-print start button 8M is close to the detection areas of the print information buttons 8J adjacent to the all-print start button 8M. In this manner, if the distance between adjacent detection areas is small, the length of the detection areas of the print information buttons 8J in the lateral direction of the operation panel 15 may be shortened. That is, portions of the detection areas of the print information buttons 8J adjacent to the all-print start button 8M are disabled (or are set as non-detection areas) to increase the distance between adjacent detection areas. Alternatively, instead of the length of the detection areas of the print information buttons 8J, the length of the detection area of the all-print start button 8M in the lateral direction of the operation panel 15 may be shortened. That is, a portion of the detection area of the all-print start button 8M adjacent to the print information buttons 8J is disabled (or is set as a non-detection area) to increase the distance between adjacent detection areas. Alternatively, the length of the detection areas of the print information buttons 8J and the detection area of the all-print start button 8M in the lateral direction of the operation panel 15 may be shortened.

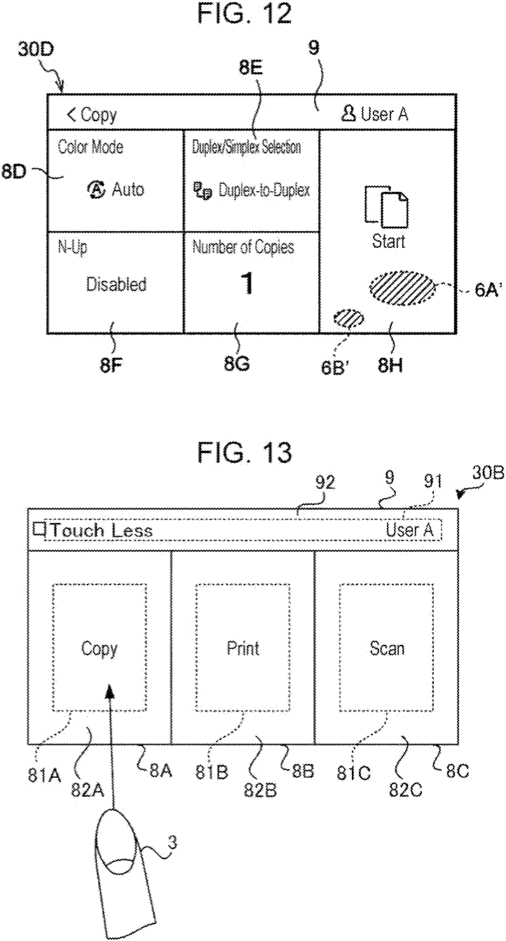

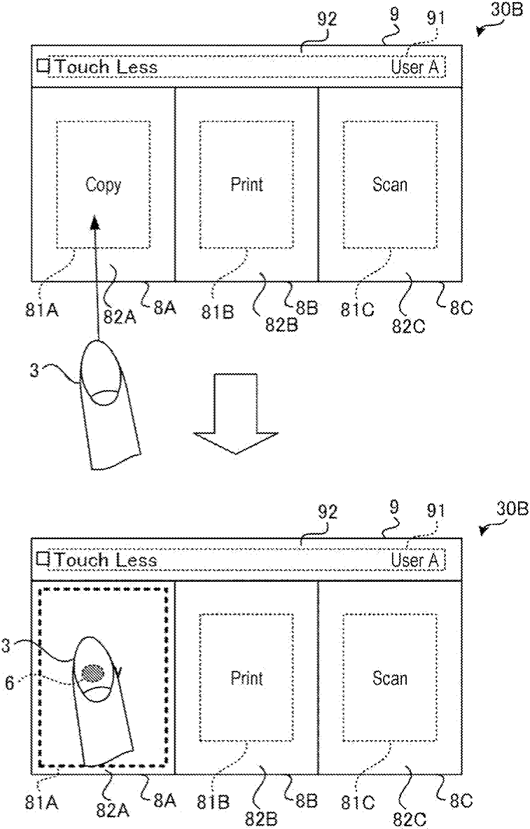

Next, the display of the home screen 30B will be described in detail as an example screen on the operation panel 15 with reference to FIG. 13.

FIG. 13 is a plan view of an example of the home screen 30B according to this exemplary embodiment.

The home screen 30B illustrated in FIG. 13 displays an image including, as an example of operation objects, the “Copy” button 8A, the “Print” button 8B, the “Scan” button 8C, and the navigation bar 9.

The “Copy” button 8A is associated with a detection area 81A and a non-detection area 82A. The detection area 81A is an area in space corresponding to the “Copy” button 8A and is an area in which the position of the finger 3 of the user is detectable. The detection area 81A has a smaller size than the “Copy” button 8A. The non-detection area 82A is an area in space corresponding to the “Copy” button 8A and is an area in which the position of the finger 3 of the user is not detectable. The non-detection area 82A is included in an area in space corresponding to the “Copy” button 8A and is other than the detection area 81A. In the example in FIG. 13, the non-detection area 82A is formed to surround the detection area 81A.

Likewise, the “Print” button 8B is associated with a detection area 81B and a non-detection area 82B. The detection area 81B is an area in space corresponding to the “Print” button 8B and is an area in which the position of the finger 3 of the user is detectable. The detection area 81B has a smaller size than the “Print” button 8B. The non-detection area 82B is an area in space corresponding to the “Print” button 8B and is an area in which the position of the finger 3 of the user is not detectable. The non-detection area 82B is included in an area in space corresponding to the “Print” button 8B and is other than the detection area 81B. In the example in FIG. 13, the non-detection area 82B is formed to surround the detection area 81B.

The “Scan” button 8C is associated with a detection area 81C and a non-detection area 82C. The detection area 81C is an area in space corresponding to the “Scan” button 8C and is an area in which the position of the finger 3 of the user is detectable. The detection area 81C has a smaller size than the “Scan” button 8C. The non-detection area 82C is an area in space corresponding to the “Scan” button 8C and is an area in which the position of the finger 3 of the user is not detectable. The non-detection area 82C is included in an area in space corresponding to the “Scan” button 8C and is other than the detection area 81C. In the example in FIG. 13, the non-detection area 82C is formed to surround the detection area 81C.

The navigation bar 9 is associated with a detection area 91 and a non-detection area 92. The detection area 91 is an area in space corresponding to the navigation bar 9 and is an area in which the position of the finger 3 of the user is detectable. The detection area 91 has a smaller size than the navigation bar 9. The non-detection area 92 is an area in space corresponding to the navigation bar 9 and is an area in which the position of the finger 3 of the user is not detectable. The non-detection area 92 is included in an area in space corresponding to the navigation bar 9 and is other than the detection area 91. In the example in FIG. 13, the non-detection area 92 is formed to surround the detection area 91.

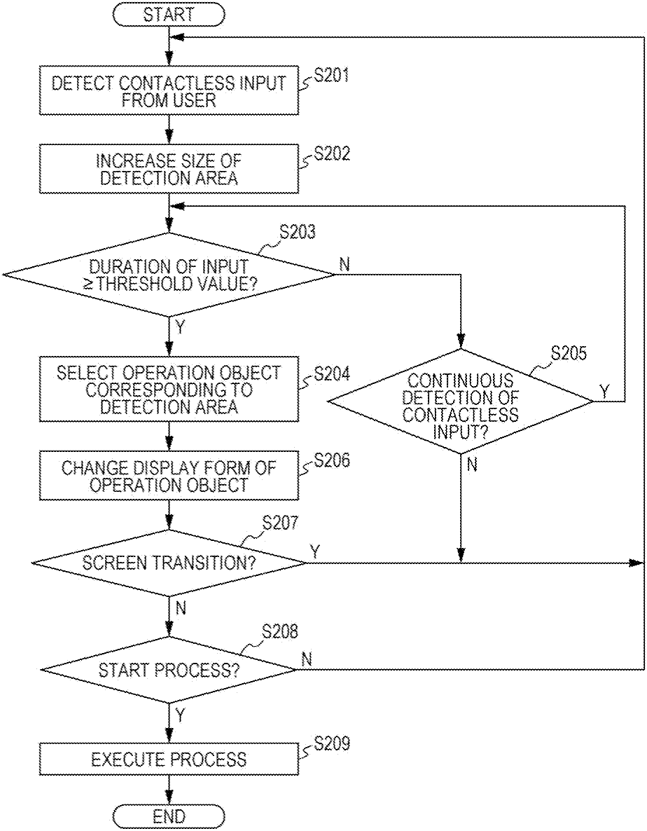

The situation in which a non-detection area is “formed to surround” a detection area, described above, is not limited to the situation in which the non-detection area is disposed along the entire periphery of the detection area. For example, if no button to be selected is adjacent to a certain button 8, no non-detection area may be disposed in a direction in which no button is present. That is, the non-detection area may be formed into an L shape or a U shape with respect to the detection area. For example, no button is located to the right of or below the “Scan” button 8C. Thus, as illustrated in FIG. 19 described below, the detection area 81C is set in a lower right portion of the “Scan” button 8C, and the non-detection area 82C is formed into an L shape so as to surround the detection area 81C.

For example, the user holds the finger 3 over the detection area 81A to perform a selection operation on the “Copy” button 8A of the home screen 30B in a contactless manner. In response to the finger 3 being detected in the detection area 81A, the cursor is displayed at a position in the detection area 81A corresponding to the operation position 6 indicated by the finger 3. The display of the cursor allows the user to understand that the selection operation has been detected. The detection area 81A has a smaller size than the “Copy” button 8A. This makes it less likely that the finger 3 accidentally enters the adjacent “Print” button 8B even if the finger 3 of the user slightly shakes, and prevents or reduces the occurrence of an input error. The same applies to a case where the user performs a selection operation on the other operation objects.

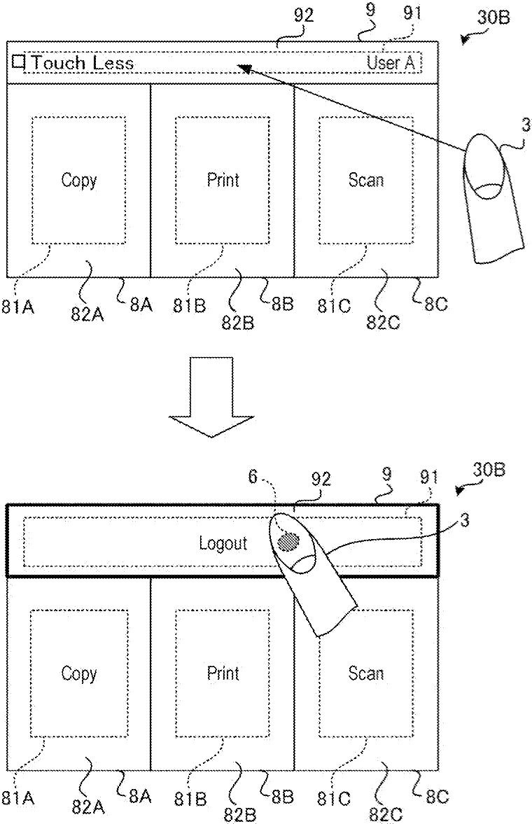

The controller 20 may increase the size of a detection area in response to detection of a contactless input to the detection area. At this time, it is desirable not to change the size of the detection areas corresponding to the operation objects other than the operation object corresponding to the detection area whose size is increased. This will be described in detail with reference to FIG. 14.

FIG. 14 is a plan view of an example of a detection area whose size is increased in the home screen 30B according to this exemplary embodiment.

As illustrated in FIG. 14, the user holds the finger 3 over the detection area 81A to perform a selection operation on the “Copy” button 8A of the home screen 30B in a contactless manner. In response to the finger 3 being detected in the detection area 81A, the size of the detection area 81A is increased. In the example in FIG. 14, the detection area 81A is enlarged to the outer edge of the “Copy” button 8A. That is, the size of the detection area 81A after detection is larger than the size of the detection area 81A before detection. This makes it less likely that the finger 3 of the user accidentally enters an area outside the detection area 81A even if the finger 3 slightly shakes, and ensures that the “Copy” button 8A is selected. At this time, the sizes of the detection areas corresponding to the “Print” button 8B, the “Scan” button 8C, and the navigation bar 9, other than the “Copy” button 8A, are not changed.

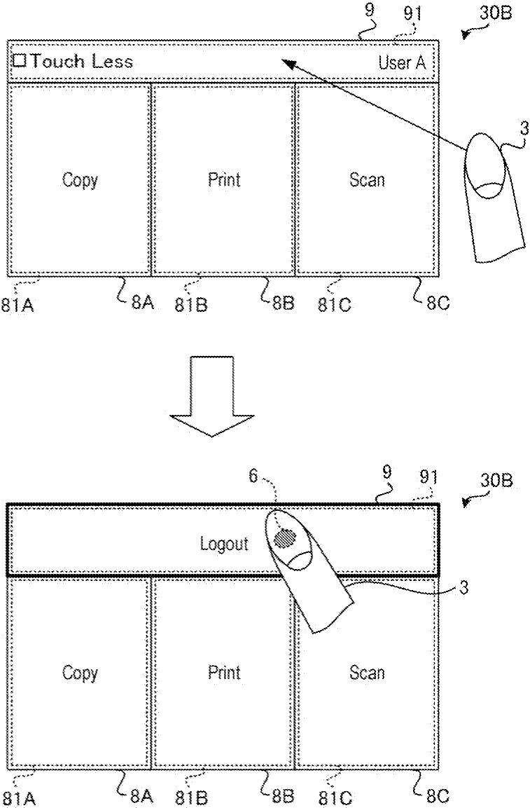

Alternatively, the controller 20 may increase the size of the operation object in response to detection of a contactless input to the detection area. In this case, the size of the detection area is increased in accordance with the increase in the size of the operation object. At this time, it is desirable not to change the size of the detection areas corresponding to the operation objects other than the operation object corresponding to the detection area whose size is increased. This will be described with reference to FIG. 15.

FIG. 15 is a plan view of an example of an operation object whose size is increased in the home screen 30B according to this exemplary embodiment.

As illustrated in FIG. 15, the user holds the finger 3 over the detection area 91 to perform a selection operation on the navigation bar 9 of the home screen 30B in a contactless manner. In response to the finger 3 being detected in the detection area 91, the size of the navigation bar 9 is increased. In the example in FIG. 15, the size of the detection area 91 is increased in accordance with the increase in the size of the navigation bar 9. That is, the size of the navigation bar 9 after detection is larger than the size of the navigation bar 9 before detection, and the size of the detection area 91 after detection is larger than the size of the detection area 91 before detection. This makes it less likely that the finger 3 of the user accidentally enters an area outside the detection area 91 even if the finger 3 slightly shakes, and ensures that the navigation bar 9 is selected. At this time, the sizes of the detection areas corresponding to the “Copy” button 8A, the “Print” button 8B, and the “Scan” button 8C, other than the navigation bar 9, are not changed.

The controller 20 may increase the size of the operation object in accordance with the shape of the operation object in response to detection of a contactless input to the detection area. Specifically, the size of the operation object is increased when the operation object is in shape of, for example, an elongated button or a small button. In the example in FIG. 15, the size of the navigation bar 9 is increased, whereas the sizes of the “Copy” button 8A, the “Print” button 8B, and the “Scan” button 8C are not changed. The shape of each operation object is determined from size information of the operation object (the number of pixels in the lateral direction × the number of pixels in the longitudinal direction). For example, an appropriate threshold value is set for each of the number of pixels in the lateral direction and the number of pixels in the longitudinal direction, and each of the number of pixels in the lateral direction and the number of pixels in the longitudinal direction is compared with the corresponding threshold value to determine a shape such as an elongated shape or a small shape. Alternatively, an operation object having a shape such as an elongated shape or a small shape may be determined in advance.

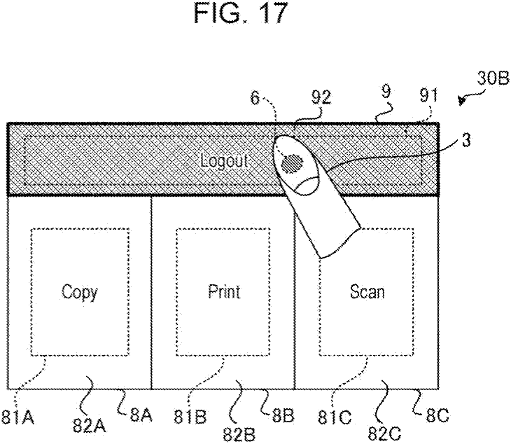

Next, a modification in which the size of the operation object illustrated in FIG. 15 is increased will be described. The controller 20 according to the modification causes an image including one or more operation objects to be displayed in the screen 30 on the operation panel 15. In response to detection of a contactless input to an operation object from the user in a detection area for detecting a contactless input, the controller 20 increases the size of the operation object. In response to the contactless input being accepted in the detection area for a predetermined period of time (threshold value) or longer, the controller 20 selects the operation object corresponding to the detection area, that is, confirms the selection of the operation object. In this modification, the detection area has the same size as the operation object. This will be described in detail with reference to FIG. 16.

FIG. 16 is a plan view of a modification of an operation object whose size is increased in the home screen 30B according to this exemplary embodiment.

In the home screen 30B illustrated in FIG. 16, unlike the example of the home screen 30B illustrated in FIG. 15, each operation object has the same size as the detection area corresponding to the operation object. Specifically, the “Copy” button 8A has the same size as the detection area 81A, and the “Print” button 8B has the same size as the detection area 81B. Further, the “Scan” button 8C has the same size as the detection area 81C, and the navigation bar 9 has the same size as the detection area 91.

As in the example illustrated in FIG. 15, the user holds the finger 3 over the detection area 91 to perform a selection operation on the navigation bar 9 of the home screen 30B in a contactless manner. In response to the finger 3 being detected in the detection area 91, the size of the navigation bar 9 is increased. In the example in FIG. 16, the size of the detection area 91 is increased in accordance with the increase in the size of the navigation bar 9. That is, the size of the navigation bar 9 after detection is larger than the size of the navigation bar 9 before detection, and the size of the detection area 91 after detection is larger than the size of the detection area 91 before detection. This makes it less likely that the finger 3 of the user accidentally enters an area outside the detection area 91 even if the finger 3 slightly shakes, and ensures that the navigation bar 9 is selected.

The size of the detection area 91 does not need to be changed in accordance with the increase in the size of the navigation bar 9. In this case, a non-detection area is formed around the detection area 91 in accordance with the increase in the size of the navigation bar 9. This makes it less likely that the finger 3 accidentally enters the detection areas corresponding to the “Copy” button 8A, the “Print” button 8B, and the “Scan” button 8C even if the finger 3 accidentally enters the non-detection area outside the detection area 91 because the finger 3 shakes, and prevents or reduces the occurrence of an input error.

Alternatively, in response to a contactless input being accepted in a detection area for a predetermined period of time (threshold value) or longer and in response to selection of the operation object corresponding to the detection area, the controller 20 may change the display form of the selected operation object. This will be described in detail with reference to FIG. 17.

FIG. 17 is a plan view of an example of an operation object selected on the home screen 30B according to this exemplary embodiment.

As illustrated in FIG. 17, in response to the selection of the navigation bar 9 being confirmed, the display form of the navigation bar 9 is changed to notify the user of the confirmation of the selection. The display form may be changed by various methods such as changing the color of the navigation bar 9, adding a hatched pattern, and changing the font of the text.

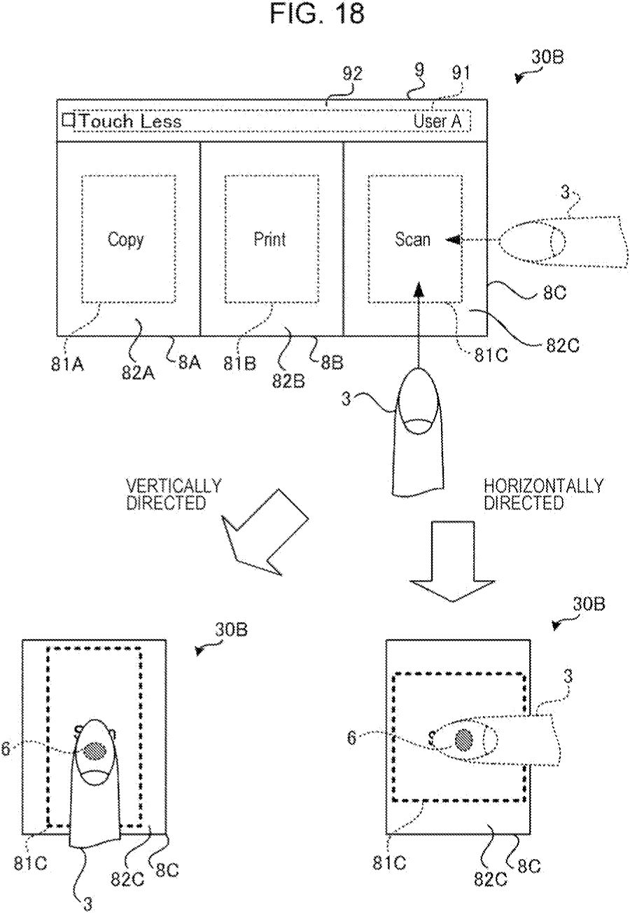

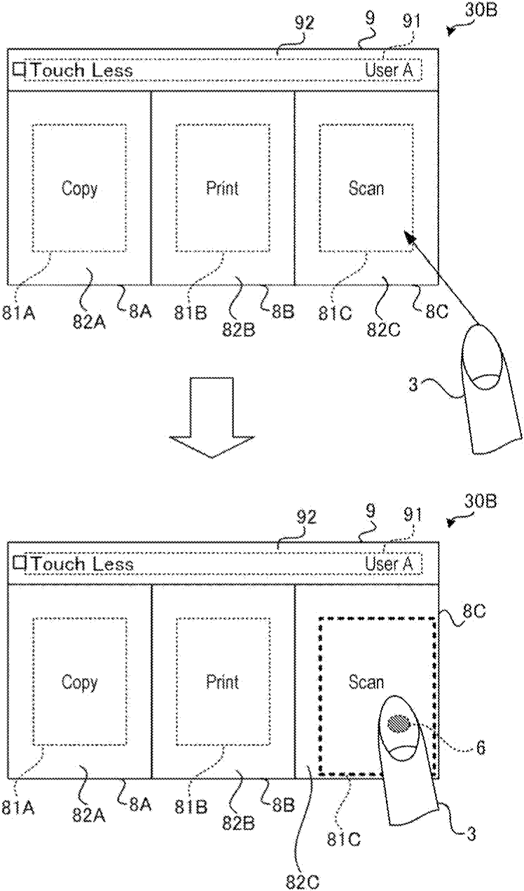

Alternatively, the controller 20 may change the shape of a detection area in accordance with the direction of a target object (e.g., the finger 3 of the user) in the detection area. This will be described in detail with reference to FIG. 18.

FIG. 18 is a plan view of an example of a detection area whose shape is changed in the home screen 30B according to this exemplary embodiment.

As illustrated in FIG. 18, the user holds the finger 3 over the detection area 81C to perform a selection operation on the “Scan” button 8C of the home screen 30B in a contactless manner. In response to the finger 3 being detected in the detection area 81C, the shape of the detection area 81C is changed in accordance with the direction of the finger 3. In the example in FIG. 18, when it is determined that the finger 3 of the user is directed vertically, the detection area 81C is enlarged in the longitudinal direction. When it is determined that the finger 3 of the user is directed horizontally, the detection area 81C is enlarged in the lateral direction. The direction in which the detection area 81C is enlarged is not limited to the example illustrated in FIG. 18. For example, it is desirable to enlarge the detection area 81C in a direction in which the finger 3 of the user is likely to shake. The direction of the finger 3 of the user may be determined from, for example, a distribution of a plurality of coordinate points acquired from within the detection area corresponding to the operation position 6. That is, since the distribution of the coordinate points in the detection area corresponding to the operation position 6 may be different depending on the direction of the finger 3 of the user, the distribution of the coordinate points in the detection area and the direction of the finger 3 of the user are associated with each other in advance. As a result, the direction of the finger 3 of the user is determined from the distribution of the coordinate points in the detection area.

Alternatively, the controller 20 may change the shape of a detection area in accordance with the position of a target object (e.g., the finger 3 of the user) in the detection area. This will be described in detail with reference to FIG. 19.

FIG. 19 is a plan view of another example of a detection area whose shape is changed in the home screen 30B according to this exemplary embodiment.

As illustrated in FIG. 19, the user holds the finger 3 over the detection area 81C to perform a selection operation on the “Scan” button 8C of the home screen 30B in a contactless manner. In response to the finger 3 being detected in the detection area 81C, the shape of the detection area 81C is changed in accordance with the position of the finger 3. In the example in FIG. 19, when it is determined that the finger 3 of the user is located in a lower right portion of the detection area 81C, the detection area 81C is enlarged to the right and downward. When it is determined that the finger 3 of the user is located in an upper right portion of the detection area 81C, the detection area 81C is enlarged to the right and upward. When it is determined that the finger 3 of the user is located in a lower left portion of the detection area 81C, the detection area 81C is enlarged to the left and downward. When it is determined that the finger 3 of the user is located in an upper left portion of the detection area 81C, the detection area 81C is enlarged to the left and upward. When it is determined that the finger 3 of the user is located at the center of the detection area 81C, the detection area 81C is enlarged as a whole.

In the foregoing description, the “Copy” button 8A, the “Print” button 8B, the “Scan” button 8C, and the navigation bar 9 are used as an example of a plurality of operation objects. A single operation object may be used. This exemplary embodiment is also applicable to, for example, the display of a single button, such as a start button, a cancel button, or an OK button.

Next, the operation of the image processing apparatus 10 according to this exemplary embodiment will be described with reference to FIG. 20.

FIG. 20 is a flowchart illustrating an example of a process based on an information processing program according to this exemplary embodiment.

First, in response to an instruction to execute a contactless input through the operation panel 15, the CPU 41 activates the information processing program and executes the steps described below.

In step S201 in FIG. 20, the CPU 41 detects a contactless input to an operation object displayed on the operation panel 15 from the user. In one example, as illustrated in FIG. 14 described above, the detection area corresponding to the operation object is configured to have a smaller size than the operation object.

In step S202, upon detection of the contactless input in step S201, in one example, as illustrated in FIG. 14 described above, the CPU 41 increases the size of the corresponding detection area. As illustrated in FIG. 15 described above, the size of the operation object and the size of the detection area may be increased.

In step S203, the CPU 41 determines whether the duration of the contactless input in the detection area whose size is increased in step S202 is greater than or equal to a threshold value. If it is determined that the duration of the contactless input is greater than or equal to the threshold value (if a positive determination is made), the process proceeds to step S204. If it is determined that the duration of the contactless input is less than the threshold value (if a negative determination is made), the process proceeds to step S205.

In step S204, the CPU 41 selects the operation object corresponding to the detection area.

In step S205, the CPU 41 determines whether the contactless input is being continuously detected. If it is determined that the contactless input is being continuously detected (if a positive determination is made), the process returns to step S203 and is repeatedly performed. If it is determined that the contactless input is not being continuously detected, that is, the detection of the contactless input is interrupted (if a negative determination is made), the process returns to step S201 and is repeatedly performed.

In step S206, in one example, as illustrated in FIG. 17 described above, the CPU 41 changes the display form of the operation object selected in step S204.

In step S207, the CPU 41 determines whether a screen transition is to be made. If it is determined that a screen transition is to be made (if a positive determination is made), a screen transition is made, and the process returns to step S201 and is repeatedly performed. If it is determined that no screen transition is to be made (if a negative determination is made), the process proceeds to step S208.

In step S208, the CPU 41 determines whether to start a specific process corresponding to the operation object (e.g., a copying process, a printing process, a scanning process, or a logout process). If it is determined that the specific process is to be started (if a positive determination is made), the process proceeds to step S209. If it is determined that the specific process is not to be started (if a negative determination is made), the process returns to step S201 and is repeatedly performed.

In step S209, the CPU 41 executes the specific process corresponding to the operation object. Then, the series of processing operations based on the information processing program ends.

According to this exemplary embodiment, therefore, when a selection operation is to be performed on an operation object displayed on a screen in a contactless manner, the detection area corresponding to the operation object is configured to have a smaller size than the operation object. This makes it less likely that the user’s finger accidentally enters an adjacent operation object even if the user’s finger slightly shakes, and prevents or reduces the occurrence of an input error.

The second exemplary embodiment described above may be implemented according to the following first to thirteenth aspects.

An information processing apparatus according to a first aspect includes a processor configured to: display an image on a screen, the image including one or more items; and, in response to detection of a contactless input to a subject item among the one or more items from a user and in response to the contactless input being accepted for a period of time longer than or equal to a threshold value in a detection area corresponding to the subject item, the detection area having a smaller size than the subject item, select the subject item corresponding to the detection area.

An information processing apparatus according to a second aspect is the information processing apparatus according to the first aspect, in which the processor is configured to set, as a non-detection area, an area that is in an area in space corresponding to the subject item and that is other than the detection area.

An information processing apparatus according to a third aspect is the information processing apparatus according to the second aspect, in which the non-detection area is formed to surround the detection area.

An information processing apparatus according to a fourth aspect is the information processing apparatus according to any one of the first to third aspects, in which the processor is configured to increase a size of the detection area in response to detection of the contactless input to the detection area.

An information processing apparatus according to a fifth aspect is the information processing apparatus according to any one of the first to fourth aspects, in which the processor is configured to increase a size of the subject item in response to detection of the contactless input to the detection area.

An information processing apparatus according to a sixth aspect is the information processing apparatus according to the fifth aspect, in which the processor is configured to increase the size of the subject item in accordance with a shape of the subject item in response to detection of the contactless input to the detection area.

An information processing apparatus according to a seventh aspect is the information processing apparatus according to any one of the fourth to sixth aspects, in which the processor is configured not to change a size of a detection area corresponding to an item other than the subject item among the one or more items in response to detection of the contactless input to the detection area corresponding to the subject item.

An information processing apparatus according to an eighth aspect is the information processing apparatus according to any one of the first to seventh aspects, in which the processor is configured to select an item from among the one or more items and change a display form of the selected item.

An information processing apparatus according to a ninth aspect is the information processing apparatus according to any one of the first to eighth aspects, in which the processor is configured to: accept the contactless input to the detection area in response to detection of a target object with which the user performs an operation in the detection area; and change a shape of the detection area in accordance with a direction of the target object in the detection area.

An information processing apparatus according to a tenth aspect is the information processing apparatus according to any one of the first to ninth aspects, in which the processor is configured to: accept the contactless input to the detection area in response to detection of a target object with which the user performs an operation in the detection area; and change a shape of the detection area in accordance with a position of the target object in the detection area.

An information processing apparatus according to an eleventh aspect includes a processor configured to: display an image on a screen, the image including one or more items; in response to detection of a contactless input to a subject item among the one or more items from a user in a detection area for detecting the contactless input to the subject item, increase a size of the subject item; and select the subject item corresponding to the detection area in response to the contactless input being accepted in the detection area for a period of time longer than or equal to a threshold value.

A non-transitory computer readable medium according to a twelfth aspect stores a program causing a computer to execute a process for information processing, the process including: displaying an image on a screen, the image including one or more items; and, in response to detection of a contactless input to a subject item among the one or more items from a user and in response to the contactless input being accepted for a period of time longer than or equal to a threshold value in a detection area corresponding to the subject item, the detection area having a smaller size than the subject item, selecting the subject item corresponding to the detection area.

An information processing method according to a thirteenth aspect includes: displaying an image on a screen, the image including one or more items; and, in response to detection of a contactless input to a subject item among the one or more items from a user and in response to the contactless input being accepted for a period of time longer than or equal to a threshold value in a detection area corresponding to the subject item, the detection area having a smaller size than the subject item, selecting the subject item corresponding to the detection area.

While the image processing apparatus 10 according to an aspect of the present disclosure has been described with reference to exemplary embodiments, the image processing apparatus 10 disclosed herein is an example, and the image processing apparatus 10 is not limited to that described in the exemplary embodiments. The exemplary embodiments may be changed or improved in various ways without departing from the scope of the present disclosure, and such changes or improvements are also included in the technical scope disclosed herein. For example, the order of the operation processes illustrated in FIGS. 8, 9, 11, and 20 may be changed without departing from the scope of the present disclosure.

In the exemplary embodiments described above, the operation processes are implemented by software, by way of example. However, processes equivalent to the operation processes illustrated in FIGS. 8, 9, 11, and 20 may be implemented by hardware. In this case, the speed of the operation processes may be increased as compared with a case where the operation processes are implemented by software.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiments described above, an information processing program is stored in the ROM 43, by way of example. However, the information processing program may be stored in a storage other than the ROM 43. An information processing program according to an exemplary embodiment of the present disclosure may be provided in a form recorded on a storage medium readable by the computer 40. For example, the information processing program may be provided in a form recorded on an optical disk such as a compact disk read only memory (CD-ROM) or a digital versatile disk read only memory (DVD-ROM). Alternatively, the information processing program may be provided in a form recorded on a portable semiconductor memory such as a USB memory or a memory card.

The ROM 43, the non-volatile memory 44, the CD-ROM, the DVD-ROM, the USB memory, and the memory card are examples of a non-transitory storage medium.

Further, the image processing apparatus 10 may download an information processing program from an external apparatus connected to the communication unit 33 via a communication line, and store the downloaded information processing program in a non-transitory storage medium. In this case, the CPU 41 of the image processing apparatus 10 reads the information processing program downloaded from the external apparatus from the non-transitory storage medium and executes an extraction process.

An image processing apparatus has been described as an example of an information processing apparatus according to some exemplary embodiments. Exemplary embodiments may be provided as a program for causing a computer to execute the functions of the information processing apparatus. Exemplary embodiments may be provided as a non-transitory computer-readable storage medium storing such a program.

In addition, the configuration of an information processing apparatus described in each of the exemplary embodiments described above is an example, and may be changed depending on the situation without departing from the scope of the present disclosure.

Additionally, the flow of a process based on a program described in each of the exemplary embodiments described above is also an example, and any unnecessary step may be deleted, a new step may be added, or the processing order may be changed without departing from the scope of the present disclosure.

In the exemplary embodiments described above, a program is executed to implement processes according to the exemplary embodiments by a software configuration using a computer, by way of example but not limitation. The exemplary embodiments may be implemented by, for example, a hardware configuration or a combination of a hardware configuration and a software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
accept an operation performed by a user in a contactless manner for each of items displayed on a screen; and
control a confirmation time for each of the items including a first item and a second item to set a confirmation time for the first item to be shorter than a confirmation time for the second item, wherein the confirmation time for each of the items is a time that is taken from when an operation performed by the user on the item is detected to when it is confirmed that the operation is selection of the item on which the operation has been detected.

2. The information processing apparatus according to claim 1, wherein:
the first item and the second item are set in accordance with a type of the items.

3. The information processing apparatus according to claim 2, wherein:
the first item comprises an item for setting an operation condition of a function associated in advance with the first item in response to selection of the first item being confirmed, and
the second item comprises an item for providing an instruction to implement a function associated in advance with the second item in response to selection of the second item being confirmed.

4. The information processing apparatus according to claim 1, wherein:
the processor is configured to set the confirmation time for each of the items in accordance with a size of a display area of the item.

5. The information processing apparatus according to claim 4, wherein:
the processor is configured to set the confirmation time for each of the items such that the confirmation time for the item increases as the size of the display area of the item increases and such that the confirmation time for the item decreases as the size of the display area of the item decreases.

6. The information processing apparatus according to claim 1, wherein:
the processor is configured to adjust the confirmation time for an item on which an operation performed by the user has been detected among the items, in accordance with a distance from a body part of the user to a display surface of the screen, the body part of the user being used to perform the operation on the item.

7. The information processing apparatus according to claim 2, wherein:
the processor is configured to adjust the confirmation time for an item on which an operation performed by the user has been detected among the items, in accordance with a distance from a body part of the user to a display surface of the screen, the body part of the user being used to perform the operation on the item.

8. The information processing apparatus according to claim 3, wherein:
the processor is configured to adjust the confirmation time for an item on which an operation performed by the user has been detected among the items, in accordance with a distance from a body part of the user to a display surface of the screen, the body part of the user being used to perform the operation on the item.

9. The information processing apparatus according to claim 4, wherein:
the processor is configured to adjust the confirmation time for an item on which an operation performed by the user has been detected among the items, in accordance with a distance from a body part of the user to a display surface of the screen, the body part of the user being used to perform the operation on the item.

10. The information processing apparatus according to claim 5, wherein:
the processor is configured to adjust the confirmation time for an item on which an operation performed by the user has been detected among the items, in accordance with a distance from a body part of the user to a display surface of the screen, the body part of the user being used to perform the operation on the item.

11. The information processing apparatus according to claim 6, wherein:
the processor is configured to set the confirmation time for the item on which the operation performed by the user has been detected such that the confirmation time for the item decreases as the distance from the body part to the display surface of the screen decreases and such that the confirmation time for the item increases as the distance from the body part to the display surface of the screen increases.

12. The information processing apparatus according to claim 7, wherein:
the processor is configured to set the confirmation time for the item on which the operation performed by the user has been detected such that the confirmation time for the item decreases as the distance from the body part to the display surface of the screen decreases and such that the confirmation time for the item increases as the distance from the body part to the display surface of the screen increases.

13. The information processing apparatus according to claim 8, wherein:
the processor is configured to set the confirmation time for the item on which the operation performed by the user has been detected such that the confirmation time for the item decreases as the distance from the body part to the display surface of the screen decreases and such that the confirmation time for the item increases as the distance from the body part to the display surface of the screen increases.

14. The information processing apparatus according to claim 9, wherein:
the processor is configured to set the confirmation time for the item on which the operation performed by the user has been detected such that the confirmation time for the item decreases as the distance from the body part to the display surface of the screen decreases and such that the confirmation time for the item increases as the distance from the body part to the display surface of the screen increases.

15. The information processing apparatus according to claim 1, wherein:
the processor is configured to adjust the confirmation time for an item on which an operation performed by the user has been detected among the items, in accordance with a detection position of the operation in a display area of the item on which the operation performed by the user has been detected.

16. The information processing apparatus according to claim 15, wherein:
the processor is configured to set the confirmation time for the item on which the operation performed by the user has been detected such that the confirmation time for the item decreases as the detection position of the operation approaches a center of the display area of the item and such that the confirmation time for the item increases as the detection position of the operation approaches an outline of the display area of the item.

17. The information processing apparatus according to claim 1, wherein:
the processor is configured to change a measurement speed of a threshold value representing a length of a confirmation time set in advance for each of the items as a numerical value to adjust the confirmation time for an item on which an operation performed by the user has been detected among the items.

18. The information processing apparatus according to claim 17, wherein:
the processor is configured to set a measurement speed per count of the threshold value representing the confirmation time set in advance for each of the items to be higher than a predetermined reference measurement speed to shorten the confirmation time for the item.

19. A non-transitory computer readable medium storing a program causing a computer to execute a process for information processing, the process comprising:
accepting an operation performed by a user in a contactless manner for each of items displayed on a screen; and
controlling a confirmation time for each of the items including a first item and a second item to set a confirmation time for the first item to be shorter than a confirmation time for the second item, wherein the confirmation time for each of the items is a time that is taken from when an operation performed by the user on the item is detected to when it is confirmed that the operation is selection of the item on which the operation has been detected.

20. An information processing method comprising:
displaying an image on a screen, the image including one or more items; and
in response to detection of a contactless input to a subject item among the one or more items from a user and in response to the contactless input being accepted for a period of time longer than or equal to a threshold value in a detection area corresponding to the subject item, the detection area having a smaller size than the subject item, selecting the subject item corresponding to the detection area.
